(19) United States
(12) Patent Application Publication
(10) Pub. No.: US 2022/0329742 A1
(43) Pub. Date: Oct. 13, 2022

(54) PHOTOGRAPHING APPARATUS FOR PHOTOGRAMMETRY, SHAPING APPARATUS, SHAPED ARTICLE SET, THREE-DIMENSIONAL DATA GENERATION APPARATUS, AND SHAPING SYSTEM

(71) Applicant: MIMAKI ENGINEERING CO., LTD., Nagano (JP)

(72) Inventors: Kyohei Maruyama, Nagano (JP); Kenji Harayama, Nagano (JP)

(73) Assignee: MIMAKI ENGINEERING CO., LTD., Nagano (JP)

(21) Appl. No.: 17/615,820

(22) PCT Filed: Jul. 9, 2020
(86) PCT No.: PCT/JP2020/026844

§ 371 Date: Dec. 1, 2021

(30) Foreign Application Priority Data
Jul. 18, 2019 (JP) 2019-132929
Aug. 21, 2019 (JP) 2019-151324
Aug. 21, 2019 (JP) 2019-151325

(51) Int. Cl. H04N 5/247; B29C 64/393; H04N 5/225

(52) U.S. Cl. CPC H04N 5/247; B29C 64/393; H04N 5/2256; B33Y 50/02

(57) ABSTRACT

A photographing apparatus for photogrammetry continuously photographs a target object performing a series of motions by synchronizing a plurality of photographing devices provided at a plurality of different viewpoints. The plurality of photographing devices include the plurality of image-capturing units that photograph the target object. Each of the plurality of photographing devices includes the plurality of primary storages each storing each image data of the target object photographed in synchronization by the plurality of image-capturing units, and the plurality of signal output units each outputting a completion signal for each of the image data when storage of each of the image data in a preceding motion of the target object into the plurality of primary storages is completed. The plurality of photographing devices perform photographing in the subsequent motion of the target object based on the completion signal of the signal output unit.

### TECHNICAL FIELD

This invention relates to a photographing apparatus for photogrammetry, a shaping apparatus, a shaped article set, a three-dimensional data generation apparatus, and a shaping system.

### BACKGROUND ART

It is known that three-dimensional data of a target object is created by a photogrammetry method (see, for example, Patent Literatures 1 to 3).

### CITATION LIST

### Patent Literature

Patent Literature 1: Japanese Unexamined Patent Publication No. 2003-14432

Patent Literature 2: Japanese Unexamined Patent Publication No. 2018-44812

Patent Literature 3: Japanese Unexamined Patent Publication No. 2018-36842

### SUMMARY OF INVENTION

### Technical Problems

A photographing apparatus for photogrammetry, a shaping apparatus, a shaped article set, a three-dimensional data generation apparatus, and a shaping system that can appropriately read a target object to create three-dimensional data when creating three-dimensional data for shaping a three-dimensional shaped article from the target object are provided.

### Solutions to Problems

The present invention is

a photographing apparatus for photogrammetry that continuously photographs a target object performing a series of motions by synchronizing a plurality of image-capturing devices provided at a plurality of different viewpoints, in which

each of the plurality of image-capturing devices includes

a plurality of image-capturing units that photograph the target object,

a plurality of primary storages each storing each image data of the target object photographed in synchronization by the plurality of image-capturing units, and

a plurality of signal output units each outputting a completion signal for each of the image data when storage of each of the image data in a preceding motion of the target object into the plurality of primary storage is completed, and

the plurality of image-capturing devices are configured to perform photographing in a subsequent motion of the target object based on the completion signal of the signal output unit.

According to the present invention, since the completion of the storage of image data into the primary storage can be recognized with the completion signal, the time interval between the photographing of a preceding motion of the target object and the photographing of a subsequent motion can be shortened. This can shorten the photographing time while appropriately performing continuous photographing. Hence, it is possible to appropriately read a target object to create three-dimensional data.

A photographing apparatus for photogrammetry according to an aspect of the present invention further includes

a control unit to which the completion signal from the signal output unit of each of the plurality of image-capturing devices is input, in which

when determining that storage of the image data into the primary storage has been completed in all the image-capturing devices based on the input completion signal, the control unit causes the plurality of image-capturing devices to execute photographing in a subsequent motion of the target object.

According to the present invention, the control unit determines, based on the completion signal, that the storage of all the image data photographed by the plurality of image-capturing devices has been completed into all the plurality of primary storages, and can execute photographing in a subsequent motion of the target object. Therefore, the control unit can execute the photographing in the subsequent motion based on a simple determination.

A photographing apparatus for photogrammetry according to an aspect of the present invention further includes

a secondary storage to which the image data obtained by photographing a preceding motion of the target object stored in the primary storage of the image-capturing device is transferred and that stores the image data obtained by photographing the series of motions of the target object, in which

the signal output unit outputs the completion signal when the image data stored in the primary storage is transferred to the secondary storage and then the transferred image data is erased from the primary storage.

According to the present invention, since the image data stored in the primary storage can be transferred to the secondary storage for each photographing, it is possible to reduce the storage capacity of the primary storage, and to reduce the cost of the primary storage.

The present invention is a shaping apparatus including

a display unit that displays the image data stored in the secondary storage of the photographing apparatus for photogrammetry, in which

the shaping apparatus is configured to generate three-dimensional data for shaping a three-dimensional shaped article from the plurality of image data selected in a display device in which the image data for shaping the three-dimensional shaped article can be selected from the plurality of image data displayed on the display unit, and to shape the three-dimensional shaped article based on the generated three-dimensional data.

According to the present invention, it is possible to discretionarily select image data to be shaped as a three-dimensional shaped article from among image data obtained by continuously photographing a target object that performs a series of motions, and to shape, based on the selected image data, the three-dimensional shaped article of the target object that performs the series of motions.

The present invention is a shaped article set having a configuration in which a plurality of the three-dimensional shaped articles showing the series of motions shaped by the shaping apparatus are arranged side by side.

According to the present disclosure, by arranging side by side a plurality of three-dimensional shaped articles showing a series of motions having been shaped, it is possible to easily grasp a change in the motion of the target object by visual recognition.

The present invention is

a photographing apparatus for photogrammetry that photographs a target object from a plurality of different viewpoints, the photographing device including

a plurality of photographing devices that photograph the target object,

a plurality of poles to which the plurality of photographing devices are attached, the plurality of poles being provided to surround the target object, and

a plurality of moving units that move each of the plurality of poles close to or away from the target object, in which

the moving unit includes a regulation member that regulates a path on which the pole moves, and

the pole is regulated by the regulation member to move on the path.

According to the present invention, it is possible to change the size of the space surrounded by the plurality of poles while stabilizing the attitude of each pole when the plurality of poles move. Therefore, even when the size of the target object changes, the position of the image-capturing device with respect to the target object can be set to an appropriate position. Thus, it is possible to create three-dimensional data by appropriately reading the target object.

In a photographing apparatus for photogrammetry according to an aspect of the present invention, in which

the plurality of poles are arranged side by side in a circumferential direction around the target object, and

the plurality of moving units are arranged such that the path extends in a radial direction orthogonal to the circumferential direction.

According to the present invention, the space surrounded by the plurality of poles is a circular space around the target object. Hence, since the distance from each of the plurality of poles to the target object becomes a constant distance, it is easy to adjust the position among the plurality of poles.

The present invention is

a three-dimensional data generation apparatus that generates three-dimensional data that is data indicating a three-dimensional shape and color of a three-dimensional target object, the three-dimensional data generation apparatus including:

a light source that irradiates the target object with light;

a camera that photographs the target object;

a light source controller that controls a motion of the light source;

a photographing controller that controls an operation of the camera; and

a three-dimensional data generator that generates the three-dimensional data based on an image photographed by the camera, in which

the photographing controller causes the camera to photograph the target object,

to acquire a light source adjustment image that is an image used for adjusting the light source, and

a three-dimensional data generation image that is an image used for generating the three-dimensional data in the three-dimensional data generator,

at least at the time of acquiring the light source adjustment image, a color sample indicating a preset color is installed around the target object,

the photographing controller causes the camera to acquire the light source adjustment image in a state where the color sample is installed around the target object, and

the light source controller determines irradiation setting that is a manner of irradiating the light source with light at the time of acquiring the three-dimensional data generation image based on the color sample appearing in the light source adjustment image, and causes the light source to irradiate the target object with light based on the irradiation setting at the time of acquiring the three-dimensional data generation image.

According to the present invention, it is possible to appropriately adjust the manner of light irradiation at the time of acquiring a three-dimensional data generation image. Therefore, it is possible to appropriately read a target object to create three-dimensional data.

In a three-dimensional data generation apparatus according to an aspect of the present invention,

the photographing controller causes the camera to acquire the light source adjustment image in a state where a plurality of the color samples are installed at different positions from one another around the target object, and

the light source controller detects a way light illuminates each portion of the target object based on each of the color samples appearing in the light source adjustment image, and determines the irradiation setting based on the detected way the light illuminates.

According to the present invention, since the irradiation setting can be made in consideration of the way light illuminates each portion of the target object, it is possible to acquire a three-dimensional data generation image in a state where each part of the target object is uniformly irradiated with light.

In a three-dimensional data generation apparatus according to an aspect of the present invention, the light source controller detects a portion of the target object with insufficient light illumination based on each of the color samples appearing in the light source adjustment image, and determines the irradiation setting so that the portion with insufficient light illumination is irradiated with more light than light at the time of acquiring the light source adjustment image.

According to the present invention, it is possible to appropriately irradiate the target object with light.

In a three-dimensional data generation apparatus according to an aspect of the present invention,

at the time of acquiring the light source adjustment image, the photographing controller causes the camera to photograph the target object from a plurality of different viewpoints from one another to acquire a plurality of the light source adjustment images, and

the light source controller determines the irradiation setting based on the color sample appearing in the plurality of light source adjustment images.

According to the present invention, it is possible to appropriately determine the irradiation setting for each portion of the target object.

In a three-dimensional data generation apparatus according to an aspect of the present invention,

at the time of acquiring the three-dimensional data generation image, the photographing controller causes the camera to photograph the target object from a plurality of different viewpoints from one another to acquire a plurality of the three-dimensional data generation images, and

at the time of acquiring the light source adjustment image, the photographing controller causes the camera to photograph the target object from a plurality of viewpoints more than viewpoints at the time of acquiring the three-dimensional data generation image to acquire a plurality of the light source adjustment images.

According to the present invention, it is possible to appropriately determine the irradiation setting while preventing an increase in the burden on processing of generating three-dimensional data.

A three-dimensional data generation apparatus according to an aspect of the present invention includes

a plurality of the light sources, in which

the light source controller determines the irradiation setting indicating a light irradiation manner by each of the plurality of light sources based on the color sample appearing in the light source adjustment image, and causes the plurality of light sources to irradiate the target object with light based on the irradiation setting at the time of acquiring the three-dimensional data generation image.

According to the present invention, it is possible to irradiate the target object with light from a plurality of directions. Therefore, by controlling each light source based on the irradiation setting, it is possible to variously change the light irradiation manner from each direction. Hence, it is possible to more appropriately irradiate the target object with light.

A three-dimensional data generation apparatus according to an aspect of the present invention including

plurality of the light sources having different color rendering indices from one another.

According to the present invention, it is possible to variously change the color rendering indices obtained by a plurality of light sources. This makes it possible to more variously change the manner of irradiating the target object with light.

In a three-dimensional data generation apparatus according to an aspect of the present invention,

the color sample is installed around the target object also at the time of acquiring the three-dimensional data generation image,

the photographing controller causes the camera to acquire the three-dimensional data generation image in a state where the color sample is installed around the target object, and

the three-dimensional data generator adjusts a color of the three-dimensional data generation image based on the color sample appearing in the three-dimensional data generation image.

According to the present invention, by appropriately performing color adjustment, it is possible to appropriately generate three-dimensional data.

The present invention is

a shaping system that shapes a three-dimensional shaped article, the shaping system including:

a three-dimensional data generation apparatus that generates three-dimensional data that is data indicating a three-dimensional shape and color of a three-dimensional target object; and

a shaping apparatus that shapes a shaped article based on the three-dimensional data, in which

the three-dimensional data generation apparatus includes

a light source that irradiates the target object with light,

a camera that photographs the target object,

a light source controller that controls a motion of the light source,

a photographing controller that controls an operation of the camera, and

a three-dimensional data generator that generates the three-dimensional data based on an image photographed by the camera,

the photographing controller causes the camera to photograph the target object,

to acquire a light source adjustment image that is an image used for adjusting the light source, and

a three-dimensional data generation image that is an image used for generating the three-dimensional data in the three-dimensional data generator,

at least at the time of acquiring the light source adjustment image, a color sample indicating a preset color is installed around the target object,

the photographing controller causes the camera to acquire the light source adjustment image in a state where the color sample is installed around the target object, and

the light source controller determines irradiation setting that is a manner of irradiating the light source with light at the time of acquiring the three-dimensional data generation image based on the color sample appearing in the light source adjustment image, and causes the light source to irradiate the target object with light based on the irradiation setting at the time of acquiring the three-dimensional data generation image.

According to the present invention, it is possible to appropriately adjust the manner of light irradiation at the time of acquiring a three-dimensional data generation image. Therefore, it is possible to appropriately read a target object to create three-dimensional data.

### EFFECT OF THE INVENTION

According to the present invention, it is possible to provide a photographing apparatus for photogrammetry, a shaping apparatus, a shaped article set, a three-dimensional data generation apparatus, and a shaping system that can appropriately read a target object to create three-dimensional data when creating three-dimensional data of the target object.

### BRIEF DESCRIPTION OF THE DRAWINGS

FIG. 1 is a schematic configuration view illustrating a control system of a photographing apparatus for photogrammetry according to the present embodiment.

FIG. 2 is an explanatory view illustrating a photographing operation by a plurality of photographing devices.

FIG. 3 is an explanatory view regarding a photographing operation of the photographing apparatus for photogrammetry.

FIG. 4 is a flowchart regarding a synchronous continuous photographing method of the photographing apparatus for photogrammetry.

FIG. 5 is a view regarding the photographing apparatus for photogrammetry and a shaping apparatus.

FIG. 6 is a view regarding a shaped article set.

FIG. 7 is a perspective view explaining the arrangement of a photographing device in the photographing apparatus for photogrammetry according to the present embodiment.

FIG. 8 is a perspective view explaining another aspect of the arrangement of the photographing device in the photographing apparatus for photogrammetry according to the present embodiment.

FIG. 9 is a perspective view explaining the arrangement of a photographing device in a photographing apparatus for photogrammetry according to a first modification.

FIG. 10 is a perspective view explaining another aspect of the arrangement of the photographing device in the photographing apparatus for photogrammetry according to the first modification.

FIG. 11 is a view explaining the arrangement of a photographing device in a photographing apparatus for photogrammetry according to a second modification.

FIG. 12 is a view explaining a photographing apparatus for photogrammetry according to a third modification.

FIG. 13 is a view explaining a shaping system according to the present embodiment.

FIG. 14 is a view explaining a shaping apparatus.

FIG. 15 is a view explaining a head unit of the shaping apparatus.

FIG. 16 is a view explaining a three-dimensional shaped article.

FIG. 17 is a view explaining a control PC.

FIG. 18 is a view explaining a three-dimensional data generation apparatus.

FIG. 19 is a view explaining a color target.

FIG. 20 is a flowchart illustrating an operation of generating three-dimensional data.

FIG. 21 is a view explaining a light source.

### DESCRIPTION OF EMBODIMENTS

An embodiment according to the present invention will be described below with reference to the drawings. Note that the present invention is not limited by this embodiment. Components in the following embodiment include those that can be easily replaced by those skilled in the art or those that are substantially the same. The components described below can be appropriately combined, and when there are a plurality of embodiments, each embodiment can be combined.

### Present Embodiment

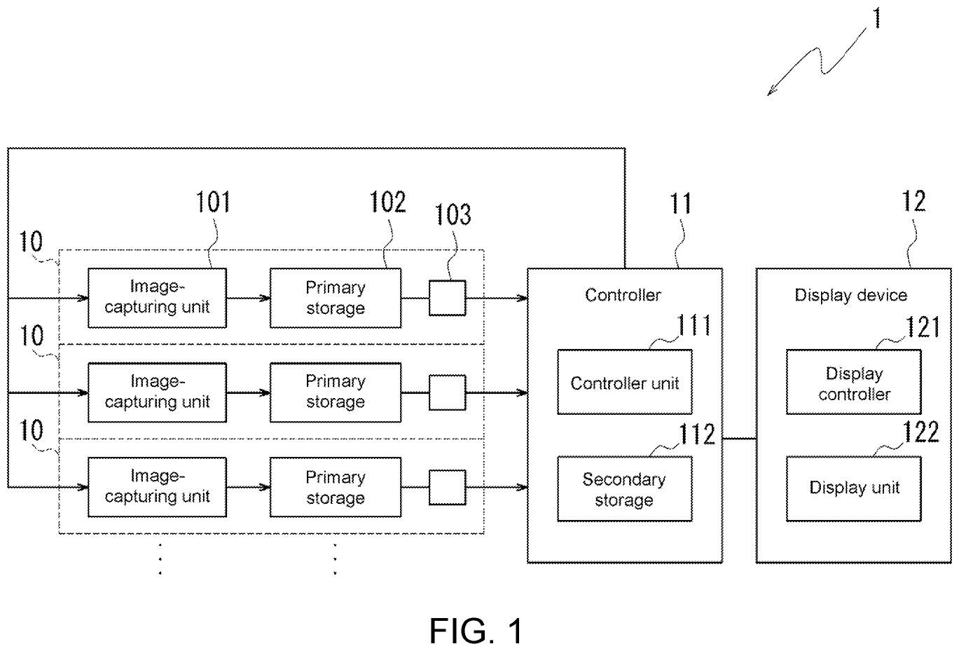

A photographing apparatus 1 for photogrammetry according to the present embodiment is a device that photographs a target object from a plurality of different viewpoints, and in particular, is a device that continuously photographs a target object that changes over time. The object that changes over time is, for example, a pitcher or the like that performs a pitching motion in baseball, and is a target object that performs a series of motions. A photographed image photographed by the photographing apparatus 1 for photogrammetry is used for generating three-dimensional data of the target object. The photographing apparatus 1 for photogrammetry will be described with reference to FIG. 1.

FIG. 1 is a schematic configuration view illustrating a control system of the photographing apparatus for photogrammetry according to the present embodiment. The photographing apparatus 1 for photogrammetry includes a plurality of photographing devices (image-capturing devices) 10, a controller 11, and a display device 12. The photographing apparatus 1 for photogrammetry performs continuous photographing by performing photographing on a preceding motion of a target object that performs a series of motions and performing photographing on a subsequent motion of the target object.

A plurality of photographing devices 10 are, for example, a plurality of cameras that photograph a target object from different viewpoints. The viewpoint is determined from the installation position of the camera and the orientation of the camera. The camera may be, for example, a camera having a connection terminal such as a USB, and is not particularly limited. When an input trigger is input, the photographing device 10 executes photographing, and outputs an output trigger (completion signal) after finishing the photographing.

The photographing device 10 includes an image-capturing unit 101, a primary storage 102, and a signal output unit 103. The image-capturing unit 101 is an image-capturing element such as an image sensor, and generates image data regarding a photographed image of the photographed target object. The primary storage 102 is, for example, a semiconductor storage device such as a cache memory, and primarily stores the image data generated by the image-capturing unit 101. When the image data is transferred to a secondary storage 112 of the controller 11, the primary storage 102 erases the stored image data. The signal output unit 103 determines whether or not the storage of the image data into the primary storage 102 is completed, and if determining that the storage of the image data into the primary storage 102 is completed, outputs an output trigger serving as a completion signal to the controller 11.

When the input trigger is input, the photographing device 10 executes photographing by the image-capturing unit 101, and stores the image data of the photographed image generated by the image-capturing unit 101 into the primary storage 102. The photographing device 10 outputs the image data generated by the image-capturing unit 101 to the secondary storage 112. When the output of the image data to the secondary storage 112 is completed, the photographing device 10 erases the image data stored in the primary storage 102, outputs an output trigger from the signal output unit 103 to the controller 11, and completes the photographing operation.

The controller 11 is electrically connected to the plurality of photographing devices 10. The controller 11 includes a control unit 111 and the secondary storage 112.

The control unit 111 includes, for example, an integrated circuit such as a central processing unit (CPU). The control unit 111 controls a photographing operation by the photographing apparatus 1 for photogrammetry. Specifically, the control unit 111 controls photographing operations of the plurality of photographing devices 10, and performs control regarding input/output triggers of the plurality of photographing devices 10.

The secondary storage 112 stores image data output from the photographing device 10. The secondary storage 112 is a discretionary storage device such as a semiconductor storage device and a magnetic storage device. The secondary storage 112 may include a plurality of types of storage devices. The secondary storage 112 is, for example, a nonvolatile storage device, and may be a memory card such as a flash memory or a storage medium such as an SSD or an HDD.

The display device 12 is electrically connected to the controller 11. The display device 12 includes a display controller 121 and a display unit 122.

The display controller 121 includes, for example, an integrated circuit such as a central processing unit (CPU). The display controller 121 acquires image data from the secondary storage 112 of the controller 11 and causes the display unit 122 to display the acquired image data. The display unit 122 is, for example, a display device such as a liquid crystal display. Note that the display unit 122 may be a display device capable of input operation, such as a touchscreen. Under display control by the display controller 121, the display unit 122 displays various images photographed by the photographing device 10.

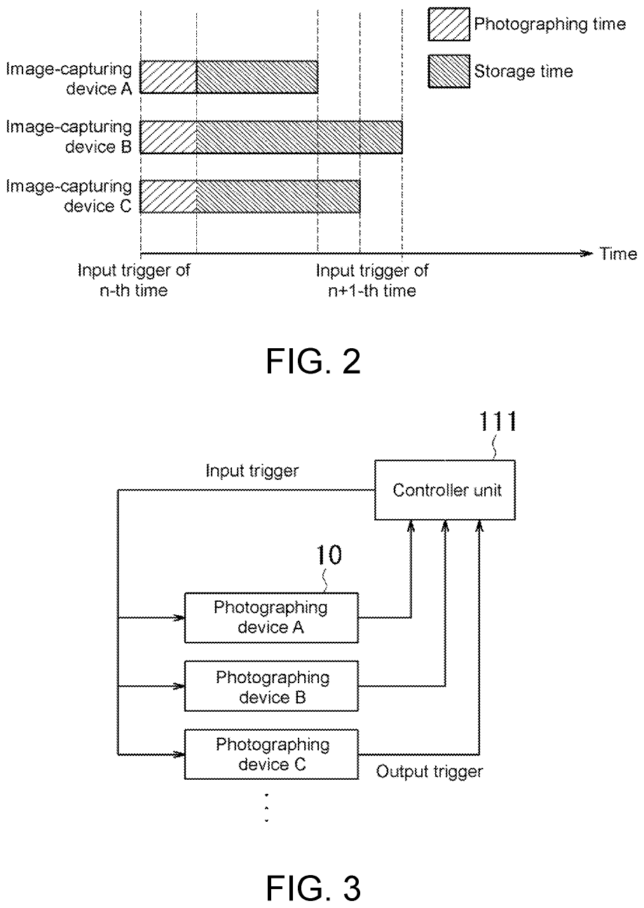

FIG. 2 is an explanatory view illustrating a photographing operation by the plurality of photographing devices 10.

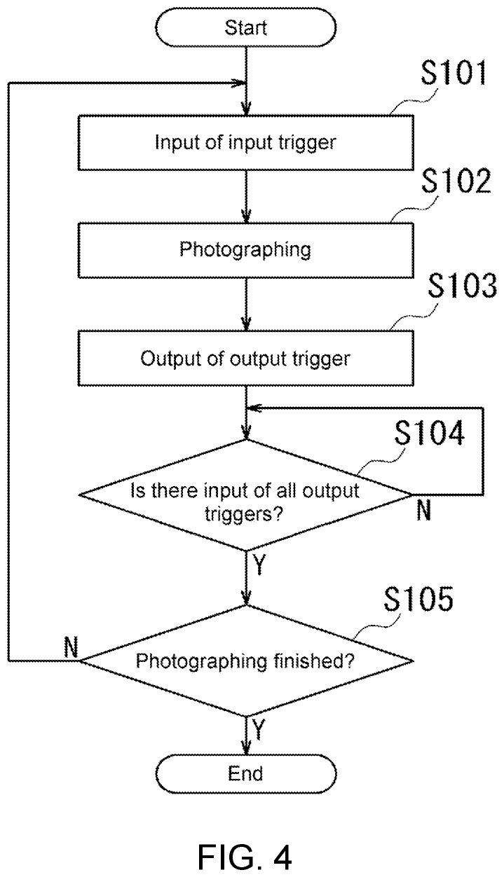

In a case where photographing is performed by the plurality of photographing devices 10 in synchronization, the control unit 111 inputs an input trigger to the plurality of photographing devices 10 at the same photographing timing. When the input trigger is input to the plurality of photographing devices 10, photographing is performed with a predetermined photographing time, and thereafter, image data is stored into the primary storage 102 with a predetermined storage time. Here, the “predetermined photographing time” refers to a time from execution of photographing by the image-capturing unit 101 to generation of image data of the photographed image by the image-capturing unit 101. This photographing time is substantially the same time interval among the plurality of photographing devices 10. The “predetermined storage time” is a time until the generated image data is stored into the primary storage 102. This storage time is different time intervals among the plurality of photographing devices 10. This is because processing related to storage is different depending on the photographing device 10. For example, image data of a photographed image photographed by the photographing device 10 may be different among the photographing devices 10, and the larger the data amount of the image data is, the longer the storage time becomes. Therefore, regarding the photographing device 10, the timing of finishing of photographing becomes different among the plurality of photographing devices 10. The storage time may vary depending on a data transfer speed or the like in addition to the data amount of the image data. In the present embodiment, the photographing apparatus 1 for photogrammetry executes the photographing operation illustrated in FIGS. 3 and 4 so that the plurality of photographing devices 10 can synchronously perform continuous photographing the photographing operation even when the storage times are different. That is, the photographing apparatus 1 for photogrammetry executes the photographing operation so as to cause the plurality of photographing devices 10 to synchronously perform photographing of the preceding motion of the target object, and cause the plurality of photographing devices 10 to synchronously perform photographing of the subsequent motion of the target object.

FIG. 3 is an explanatory view regarding the photographing operation of the photographing apparatus for photogrammetry.

FIG. 4 is a flowchart regarding the synchronous continuous photographing method of the photographing apparatus for photogrammetry. The synchronous continuous photographing method in FIGS. 3 and 4 is a method of continuously photographing the target object by synchronizing the plurality of photographing devices 10 provided at a plurality of different viewpoints.

The photographing apparatus 1 for photogrammetry first execute steps S101, S102, and S103 (photographing steps) in which the plurality of photographing devices 10 photograph the target object based on the input trigger. Thereafter, the photographing apparatus 1 for photogrammetry executes step S104 (determination step) of determining whether or not the plurality of primary storages 102 are in a state of being able to store the image data after the photographing of the target object by the plurality of photographing devices 10. If determining that the plurality of primary storages 102 are in a state of being able to store the image data, the photographing apparatus 1 for photogrammetry executes step S101 (output step) of outputting the input trigger to the plurality of photographing devices 10.

The photographing operation of the photographing apparatus 1 for photogrammetry will be specifically described below.

In the photographing apparatus 1 for photogrammetry, first, the control unit 111 synchronously outputs the input trigger to the plurality of photographing devices 10 (step S101). When an input trigger is input, each of the plurality of photographing devices 10 executes photographing with a predetermined photographing time to generate image data and executes storage of the image data generated with a predetermined storage time into the primary storage 102, and ends the photographing operation (step S102).

Each of the plurality of photographing devices 10 outputs an output trigger to the control unit 111 after photographing the target object (step S103). Specifically, the photographing device 10 determines whether or not the storage of the image data into the primary storage 102 is completed by the signal output unit 103 after photographing the target object. In the photographing device 10, after it is determined that the storage of the image data into the primary storage 102 is completed by the signal output unit 103, the image data is transferred from the primary storage 102 to the secondary storage 112. Then, upon completing the transfer of the image data to the secondary storage 112, the photographing device 10 erases the image data stored in the primary storage 102. Upon erasing the image data stored in the primary storage 102, the photographing device 10 outputs an output trigger serving as a completion signal from the signal output unit 103 to the controller 11. At this time, since each of the plurality of photographing devices 10 has a different storage time in step S102, the timing of finishing of the photographing is different as illustrated in FIG. 2. Therefore, in step S103, the timing of the output trigger output from the photographing device 10 to the control unit 111 becomes different.

The control unit 111 determines whether or not there is an input of output triggers output from all the photographing devices 10 (step S104). In step S104, the control unit 111 performs determination using an AND function, for example, and determines whether or not all output triggers output from the photographing device 10 have been input. Then, by the determination based on step S104, the control unit 111 determines whether or not the plurality of primary storages 102 are in a photographable state of being able to store image data. That is, since the output trigger is output after the image data is transferred from the primary storage 102 to the secondary storage 112, the image data is in a state of being able to be stored in the primary storage 102 at the time of inputting the output trigger to the control unit 111.

If determining that the output triggers are input from all the photographing devices 10 in step S104 (step S104: Yes), the control unit 111 determines whether or not the photographing is finished (step S105). On the other hand, if determining that the output triggers have not been input from all the photographing devices 10 in step S104 (step S104: No), the control unit 111 repeatedly executes step S104 until the output triggers are input from all the photographing devices 10.

In step S105, if determining that the photographing is finished (step S105: Yes), the control unit 111 finishes the photographing operation by the photographing apparatus 1 for photogrammetry. On the other hand, if determining that the photographing is not finished in step S105 (step S105: No), the control unit 111 proceeds to step S101 again to output the input trigger to the plurality of photographing devices 10.

Thus, the photographing apparatus 1 for photogrammetry can cause the plurality of photographing devices 10 to synchronously perform photographing of the preceding motion of the target object, and can cause the plurality of photographing devices 10 to synchronously perform photographing of the subsequent motion of the target object. Note that the finishing of photographing in step S105 is determined based on, for example, whether the number of times of photographing related to continuous photographing has reached a predetermined number of times set in advance or whether the photographing time related to continuous photographing has reached a predetermined time set in advance.

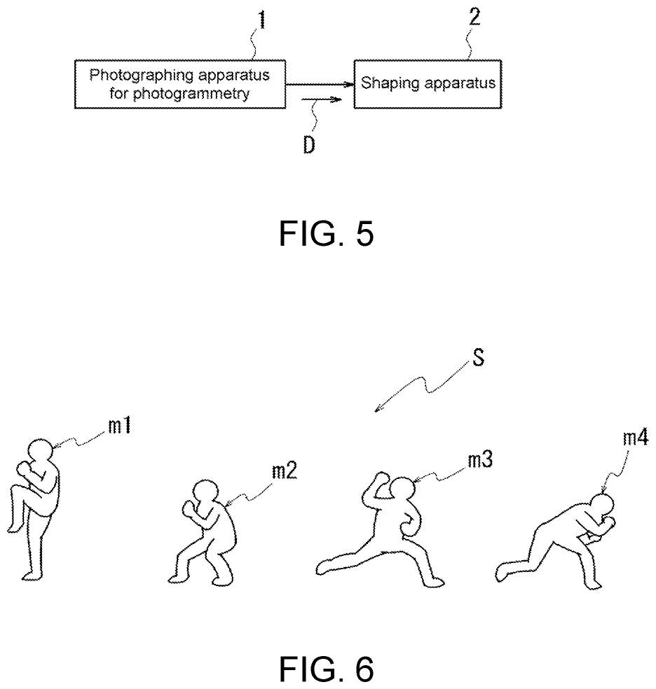

Next, a shaping apparatus 2 and a shaped article set S using image data photographed by the photographing apparatus 1 for photogrammetry will be described with reference to FIGS. 5 and 6.

FIG. 5 is a view regarding the photographing apparatus for photogrammetry and the shaping apparatus.

FIG. 6 is a view regarding the shaped article set.

Here, image data D photographed by the photographing apparatus 1 for photogrammetry is acquired by the plurality of photographing devices 10 continuously photographing in synchronization the target object performing a series of motions. When shaping a three-dimensional shaped article of the target object, it is necessary to generate three-dimensional data for shaping the three-dimensional shaped article. For example, regarding a target object that performs a series of motions, in a case of shaping a three-dimensional shaped article of the target object that performs the preceding motion, three-dimensional data is generated based on a plurality of image data D photographed in the preceding motion of the target object. In a case of shaping a three-dimensional shaped article of the target object that performs the subsequent motion, three-dimensional data is generated based on the plurality of image data D photographed in the subsequent motion of the target object. At this time, the image data D to be used is discretionary image data D selected from the plurality of image data D displayed on the display unit 122 of the display device 12.

As shown in FIG. 5, when acquiring the image data D from the photographing apparatus 1 for photogrammetry, the shaping apparatus 2 generates three-dimensional data for shaping a three-dimensional shaped article from the acquired image data D. Specifically, when generating three-dimensional data of the target object that performs the preceding motion, the shaping apparatus 2 uses the plurality of image data D photographed in the preceding motion of the target object. When generating three-dimensional data of the target object that performs the subsequent motion, the shaping apparatus 2 uses the plurality of image data D photographed in the subsequent motion of the target object. Then, the shaping apparatus 2 shapes the three-dimensional shaped article based on the generated three-dimensional data. Note that the shaping apparatus 2 may be any shaping apparatus, and for example, may be an apparatus that ejects a shaping ink by the inkjet method to form a unit layer, and shapes a three-dimensional shaped article by layering the unit layer.

As shown in FIG. 6, a plurality of three-dimensional shaped articles (m1 to m4) indicating the series of motions shaped by the shaping apparatus 2 can be provided as the shaped article set S by arranging them side by side. For the shaped article set S shown in FIG. 6, a pitcher who performs a pitching operation of baseball is applied as the three-dimensional shaped article (m1 to m4) indicating the series of motions. The shaped article set S includes a three-dimensional shaped article of the target object that performs the preceding motion and a three-dimensional shaped article of the target object that performs the subsequent motion, whereby the three-dimensional shaped article can be changed along the time series. FIG. 6 exemplifies the shaped article (m1 to m4) with a pitching form of baseball as the shaped article set S, but the shaped article set S is not limited thereto. For example, it may be a shaped article of a swing form of golf.

As described above, the photographing apparatus 1 for photogrammetry according to the present embodiment has the following configuration.

(1) The photographing apparatus 1 for photogrammetry continuously photographs a target object performing a series of motions by synchronizing the plurality of photographing devices 10 (image-capturing devices) provided at a plurality of different viewpoints.

The plurality of photographing devices 10 include the plurality of image-capturing units 101 that photograph the target object.

Each of the plurality of photographing devices 10 includes the plurality of primary storages 102 each storing each image data D of the target object photographed in synchronization by the plurality of image-capturing units 101, and the plurality of signal output units 103 each outputting a completion signal for each of the image data when storage of each of the image data D in a preceding motion of the target object into the plurality of primary storages 102 is completed.

The plurality of photographing devices 10 perform photographing in the subsequent motion of the target object based on the completion signal of the signal output unit 103.

With this configuration, when the storage of each of the image data D in the preceding motion of the target object into the primary storage 102 is completed, the completion signal can be output from the signal output unit 103. Therefore, with the completion signal, it is possible to recognize the completion of the storage of the image data D into the primary storage 102.

Thus, since the photographing in the subsequent motion of the target object can be performed without adding a margin, the time interval (photographing interval) between the photographing of the preceding motion of the target object and the photographing of the subsequent motion can be shortened. Hence, it is possible to shorten the photographing time while appropriately performing continuous photographing. That is, it is possible to appropriately read a target object to create three-dimensional data.

The photographing apparatus 1 for photogrammetry according to the present embodiment has the following configuration.

(2) The photographing apparatus 1 for photogrammetry further includes the control unit 111 to which a completion signal from the signal output unit 103 of each of the plurality of photographing devices 10 is input.

When determining that the storage of the image data D into the primary storage 102 in all the photographing devices 10 is completed based on the completion signal having been input, the control unit 111 causes the plurality of photographing devices 10 to execute photographing in the subsequent motion of the target object.

With this configuration, the control unit 111 can determine, based on the completion signal, that the storage of all the image data D photographed by the plurality of photographing devices 10 into all the plurality of primary storages 102 has been completed, and can execute the photographing in the subsequent motion of the target object. Therefore, the control unit 111 can execute the photographing in the subsequent motion based on a simple determination.

The photographing apparatus 1 for photogrammetry according to the present embodiment has the following configuration.

(3) The photographing apparatus 1 for photogrammetry further includes the secondary storage 112 to which the image data D obtained by photographing the preceding motion of the target object stored in the primary storage 102 is transferred, the secondary storage 112 storing the image data D obtained by photographing the series of motions of the target object.

After the image data D stored in the primary storage 102 is transferred to the secondary storage 112, when the transferred image data D is erased from the primary storage 102, the signal output unit 103 outputs a completion signal.

With this configuration, since the image data D stored in the primary storage 102 can be transferred to the secondary storage 112 for each photographing, the storage capacity of the primary storage 102 can be reduced, and the cost of the primary storage 102 can be reduced.

It is also possible to specify as the shaping apparatus 2 using the photographing apparatus 1 for photogrammetry according to the present embodiment.

Specifically,

(4) The photographing apparatus 1 for photogrammetry includes the display device 12.

The image data D stored in the secondary storage 112 is displayed on the display unit 122 of the display device 12.

In the display device 12, the image data D for shaping the three-dimensional shaped article is selectable from the plurality of image data D displayed on the display unit 122.

The shaping apparatus 2 generates three-dimensional data for shaping a three-dimensional shaped article from the plurality of image data D selected with the display device 12, and shapes the three-dimensional shaped article based on the generated three-dimensional data.

With this configuration, the image data D of the target object to shape the three-dimensional shaped article can be selected with the display device 12. Therefore, it is possible to discretionarily select the image data D from the image data D obtained by continuously photographing a target object that performs a series of motions, and it is possible to shape, based on the selected image data, the three-dimensional shaped article of the target object that performs the series of motions.

It is also possible to specify as the shaped article set S in which a plurality of three-dimensional shaped articles shaped by the shaping apparatus 2 according to the present embodiment are arranged side by side.

Specifically,

(5) In the shaped article set S, a plurality of three-dimensional shaped articles showing a series of motions shaped by the shaping apparatus 2 are arranged side by side.

With this configuration, since the arrangement of the plurality of three-dimensional shaped articles showing the series of motions having been shaped can be provided as the shaping set S, the change in the motion of the three-dimensional shaped article can be easily grasped by visual recognition.

The display device 12 of the photographing apparatus 1 for photogrammetry according to the present embodiment has the following configuration.

(6) The display unit 122 that displays the image data D stored in the secondary storage 112 is included, and the image data D for shaping the three-dimensional shaped article is selectable from the plurality of image data D displayed on the display unit 122.

With this configuration, it is possible to select, with the display device 12, the image data D of the target object of which a three-dimensional shaped article is shape d, and thus it is possible to discretionarily select the image data D to be shaped as a three-dimensional shaped article from among the image data D obtained by continuously photographing the target object that performs a series of motions.

The shaping apparatus 2 using image data photographed by the photographing apparatus 1 for photogrammetry according to the present embodiment has the following configuration.

(7) Three-dimensional data for shaping a three-dimensional shaped article is generated from the plurality of image data D selected in the display device 12, and the three-dimensional shaped article is shaped based on the generated three-dimensional data.

With this configuration, the three-dimensional shaped article of the target object that performs the series of motions can be shaped by the shaping apparatus 2.

Note that, in the present embodiment, if the output triggers are not input from all the photographing devices 10 in step S104, the control unit 111 executes step S104 until the output triggers are input from all the photographing devices 10, but the present invention is not limited to this configuration. In step S104, if no output triggers are input from all the photographing devices 10, the control unit 111 may determine whether or not a preset count time has been exceeded, and if determines that the count time has been exceeded, the control unit 111 may output an error.

In the present embodiment, the secondary storage 112 is provided in the controller 11, but it may be provided in each of the plurality of image-capturing devices 10. Since the photographing device 10 includes the secondary storage 112, the transfer speed of the image data D from the primary storage 102 to the secondary storage 112 can be increased. It is therefore possible to promptly output the output trigger from the signal output unit 103, and to shorten the photographing interval. At this time, the primary storage 102 and the secondary storage 112 may be configured to be integrated.

A specific arrangement example of the photographing device 10 in the photographing apparatus 1 for photogrammetry of the present embodiment will be described below.

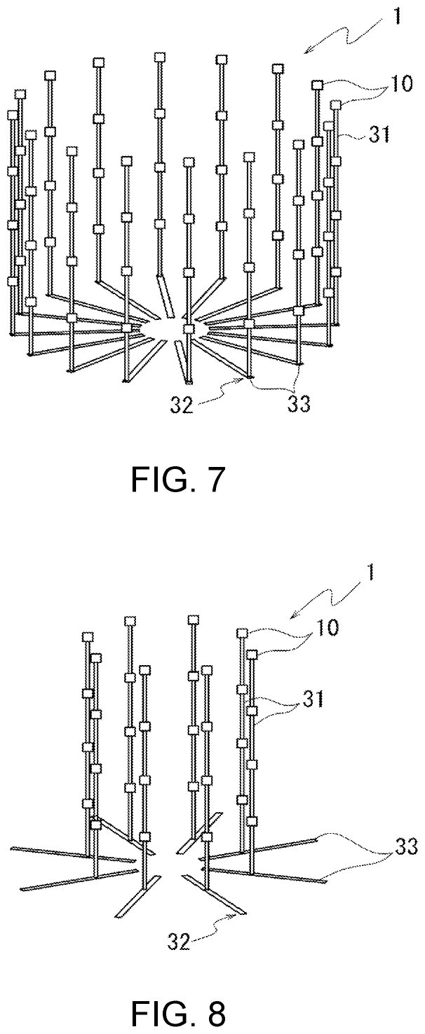

FIG. 7 is a perspective view explaining the arrangement of the photographing device 10 in the photographing apparatus 1 for photogrammetry.

FIG. 8 is a perspective view explaining another aspect of the arrangement of the photographing device 10 in the photographing apparatus 1 for photogrammetry.

As shown in FIG. 7, the photographing apparatus 1 for photogrammetry includes the plurality of photographing devices 10, a plurality of poles 31, and a plurality of moving units 32.

The plurality of photographing devices 10 are, for example, a plurality of cameras. The camera may be, for example, a camera having a connection terminal such as a USB, and is not particularly limited. The photographing device 10 photographs a target object and generates a photographed image. The photographing operation of the plurality of photographing devices 10 is controlled by a controller not illustrated, and specifically, is controlled to perform continuous photographing in synchronization.

The plurality of poles 31 have a pillared shape extending in the longitudinal direction, and are arranged such that the longitudinal direction is the vertical direction. The plurality of poles 31 are arranged to surround the periphery of the target object to be photographed. Specifically, the plurality of poles 31 are arranged side by side in the circumferential direction around the target object, so that they are arranged in a circular shape in plan view as viewed from the vertical direction. The plurality of photographing devices 10 are attached to each of the poles 31. The plurality of photographing devices 10 are arranged at equal intervals in the longitudinal direction of the pole 31. The number of the photographing devices 10 attached to the pole 31 is not particularly limited, and the photographing devices 10 may be configured to be detachable. A lower end portion of the pole 31 in the vertical direction is movably connected to the moving unit 32. The pole 31 may be configured to be extendable in the longitudinal direction. Examples of the extendable poles 31 include a nested multi-tube structure.

The plurality of moving units 32 move the pole 31 to be connected in a predetermined moving direction along the path, and are arranged on an installation surface on which the photographing apparatus 1 for photogrammetry is installed. The moving unit 32 includes a guide rail (guiding unit) 33 as a regulation member that regulates and guides the movement of the pole 31 to be connected. The guide rail 33 may have sliding resistance by being clamped, for example, at a portion coupled to the pole 31, or may have sliding resistance by being pressed by a pressing member using a spring or the like, and is not particularly limited as long as the guide rail regulates movement and guides the guide rail. The moving direction of the pole 31 of the moving unit 32 is a forward and backward direction of approaching (forward) or moving away (backward) from the target object. Specifically, the forward and backward direction is a circular radial direction formed by the plurality of poles 31. Therefore, the plurality of moving units 32 are arranged radially outward in the radial direction from the center of the target object.

The photographing apparatus 1 for photogrammetry is configured to be assembled, and can be conveyed in a state before assembly. The photographing apparatus 1 for photogrammetry before assembly is in a state where the photographing device 10 and the pole 31 are separated from the moving unit 32, and can be conveyed in a state where the plurality of poles 31 are bundled and the plurality of moving units 32 are bundled.

When the photographing apparatus 1 for photogrammetry is assembled, first, the plurality of moving units 32 are installed on the installation surface. At this time, the plurality of moving units 32 are installed such that the forward and backward direction becomes radial around the target object. Thereafter, the lower end portions of the plurality of poles 31 are connected to the plurality of corresponding moving units 32, so that the plurality of poles 31 are erected in the vertical direction, and the assembly of the photographing apparatus 1 for photogrammetry is completed.

An aspect of the photographing apparatus 1 for photogrammetry will be described. The photographing apparatus 1 for photogrammetry is configured to be adjustable of the number of the plurality of poles 31 and the plurality of moving units 32 according to the size of the target object to be photographed. FIG. 7 is an aspect of the photographing apparatus 1 for photogrammetry when the target object is large, and FIG. 8 is an aspect of the photographing apparatus 1 for photogrammetry when the target object is smaller than that in FIG. 7.

In the case of FIG. 7, the photographing apparatus 1 for photogrammetry can photograph a large target object by positioning the position of the pole 31 with respect to the moving unit 32 to the end portion on the backward side in the forward and backward direction.

On the other hand, in the case of FIG. 8, the photographing apparatus 1 for photogrammetry can photograph a small target object by positioning the position of the pole 31 with respect to the moving unit 32 to the forward side in the forward and backward direction compared with that in FIG. 7. At this time, in FIG. 8, by positioning the pole 31 on the forward side, the interval in the circumferential direction between the plurality of poles 31 become narrowed. When the interval in the circumferential direction between the plurality of poles 31 are narrow, the interval between the poles 31 can be adjusted by thinning out any of the poles 31 and the moving unit 32.

As described above, the photographing apparatus 1 for photogrammetry according to the present embodiment has the following configuration.

(8) The photographing apparatus 1 for photogrammetry photographs a target object from a plurality of different viewpoints.

The photographing apparatus 1 for photogrammetry includes the plurality of photographing devices 10 that photograph a target object, the plurality of poles 31 to which the plurality of photographing devices 10 are attached, the plurality of poles 31 being provided to surround the target object, and the plurality of moving units 32 that move each of the plurality of poles 31 close to or away from the target object.

The moving unit 32 includes the guide rail 33 (regulation member) that regulates a path on which the pole 31 moves.

The pole 31 is regulated by the guide rail 33 to move on the path.

With this configuration, the plurality of poles 31 can be moved along the forward and backward direction on the path by the plurality of moving units 32. At this time, since each of the poles 31 moves on the path while being regulated by the guide rail 33, the size of the space surrounded by the plurality of poles 31 can be changed while stabilizing the attitude of each of the poles 31 when each of the poles 31 moves.

Hence, even in a case of photographing a target object of a different size, the position of the image-capturing device 10 can be set to an appropriate position according to the size of the target object by moving the plurality of poles 31 in the forward and backward direction on the path.

Hence, photographing of the target object can be appropriately performed. Since the number of photographing devices 31, poles 31, and moving units 32 to be used can be adjusted according to the size of the target object, an apparatus configuration suitable for the size of the target object can be provided. Hence, since it is not necessary to have a plurality of photogrammetry apparatuses according to the size of the target object, an increase in apparatuses cost can be suppressed.

The photographing apparatus 1 for photogrammetry according to the present embodiment has the following configuration.

(9) The plurality of poles 31 are arranged side by side in the circumferential direction around the target object.

The plurality of moving units 32 are arranged such that the path extends in the radial direction orthogonal to the circumferential direction.

With this configuration, the space surrounded by the plurality of poles 31 can be a circular space around the target object. Therefore, the distance from each of the plurality of poles 31 to the target object can be a constant distance, and the position adjustment of the plurality of poles 31 in the forward and backward direction can be made easy.

Note that, in the first embodiment, the position in the vertical direction of the photographing device 10 attached to the adjacent pole 31 is not particularly mentioned, but the position in the vertical direction of the photographing device 10 may be as follows.

(i) The positions in the vertical direction of the photographing devices 10 attached to the adjacent poles 31 are the same positions, and the plurality of photographing devices 10 may be arranged in a lattice shape in the circumferential direction in which the plurality of poles 31 are arranged.

(ii) The positions in the vertical direction of the photographing devices 10 attached to the adjacent poles 31 are staggered positions, and the plurality of photographing devices 10 may be arranged in a staggered manner in the circumferential direction in which the plurality of poles 31 are arranged.

### First Modification

A photographing apparatus for photogrammetry according to a modification will be described below.

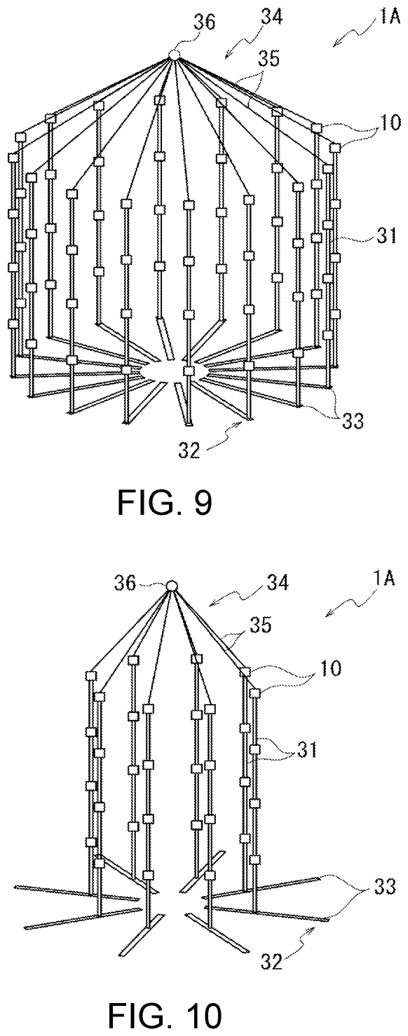

FIG. 9 is a perspective view explaining the arrangement of the photographing device 10 in a photographing apparatus 1A for photogrammetry according to the first modification.

FIG. 10 is a perspective view explaining another aspect of the arrangement of the photographing device 10 in the photographing apparatus 1A for photogrammetry.

Note that, in the following description, parts that are different from those of the photographing apparatus 1 for photogrammetry according to the present embodiment will be described, and the same parts will be described with the same reference numerals.

A photographing apparatus 1A for photogrammetry according to a first modification further includes a coupling section 34 that bundles the plurality of poles 31 into the photographing apparatus 1 for photogrammetry according to the present embodiment (see FIG. 7). The coupling section 34 is connected to the upper end portions of the plurality of poles 31. The coupling section 34 has, for example, an umbrella framework structure.

Specifically, the coupling section 34 includes a plurality of rod-shaped portions 35 and a main portion 36. The plurality of rod-shaped portions 35 are coupled to the upper end portions of the plurality of poles 31. The plurality of rod-shaped portions 35 extend from the upper end portions of the plurality of poles 31 toward the apex on the upper side of the center of the plurality of poles 31 arranged in a circular shape, and are formed in a longitudinally elongated rod shape. The main portion 36 is coupled to the end portions of the plurality of rod-shaped portions 35 on the side opposite to the side on which the poles 31 are coupled, and bundles the plurality of rod-shaped portions 35 at the apex. The coupling parts between the plurality of poles 31 and the plurality of rod-shaped portions 35 are movably coupled, and the coupling section between the plurality of rod-shaped portions 35 and the main portion 36 is movably coupled.

The plurality of poles 31 are in a state where the upper end portions are coupled to the coupling section 34, and the lower end portions are coupled to the guide rail 33. In this state, when the plurality of poles 31 are moved by the plurality of moving units 32, the plurality of poles 31 move synchronously because they are coupled by the coupling section 34. That is, the plurality of poles 31 are coupled by the coupling section 34, thereby moving at the same timing and with substantially the same movement amount. With the movement of the plurality of poles 31, the main portion 36 of the coupling section 34 moves in the vertical direction, and the plurality of rod-shaped portions 35 open and close around the main portion 36. In other words, the coupling section 34 moves the plurality of poles 31 so as to approach one another by closing the plurality of rod-shaped portions 35 around the main portion 36. When the plurality of poles 31 move synchronously by the coupling section 34, the lower end portion of the pole 31 moves while being guided by the guide rail 33.

Similarly to the photographing apparatus 1 for photogrammetry according to the present embodiment (see FIG. 7), the photographing apparatus 1A for photogrammetry according to the first modification is configured to be assembled, and can be conveyed in a state before assembly.

The photographing apparatus 1 for photogrammetry before assembly is in a state where the photographing device 10, the plurality of poles 31, and the coupling section 34 are separated from the moving unit 32. When the main portion 36 moves downward in the vertical direction, the plurality of poles 31 and the coupling section 34 are folded such that the plurality of poles 31 and the plurality of rod-shaped portions 35 overlap each other in the radial direction. The plurality of poles 31 and the coupling section 34 may be separable. The plurality of poles 31 and the plurality of rod-shaped portions 35 can be folded and bundled, and the plurality of moving units 32 can be conveyed in a bundled state.

When the photographing apparatus 1 for photogrammetry is assembled, first, the plurality of moving units 32 are installed on the installation surface. At this time, the plurality of moving units 32 are installed such that the forward and backward direction becomes radial around the target object. Thereafter, the plurality of poles 31 and the plurality of rod-shaped portions 35 are opened and developed around the main portion 36. Then, the lower end portions of the plurality of poles 31 are connected to the plurality of corresponding moving units 32, so that the plurality of poles 31 are erected in the vertical direction, and the assembly of the photographing apparatus 1B for photogrammetry is completed.

Next, an aspect of photographing apparatus 1A for photogrammetry according to the first modification will be described. FIG. 9 is an aspect of the photographing apparatus 1A for photogrammetry in a case where the target object is large, and FIG. 10 is an aspect of the photographing apparatus 1A for photogrammetry in a case where the target object is small as compared with FIG. 9.

In the case of FIG. 9, in order to photograph a large target object, the photographing apparatus 1A for photogrammetry positions the pole 31 with respect to the moving unit 32 at the end portion on the backward side in the forward and backward direction. At this time, the coupling section 34 is in a state of opening as compared with that in FIG. 10, that is, the angle of the rod-shaped portion 35 connecting the upper end portion and the apex of the pole 31 with respect to the horizontal plane is smaller than that in FIG. 10.

On the other hand, in the case of FIG. 10, in order to photograph a small target object, the photographing apparatus 1 for photogrammetry positions the pole 31 with respect to the moving unit 32 on the forward side in the forward and backward direction compared with that in FIG. 9. At this time, the coupling section 34 is in a state of closing as compared with that in FIG. 9, that is, the angle of the rod-shaped portion 35 connecting the upper end portion and the apex of the pole 31 with respect to the horizontal plane is larger than that in FIG. 9. In FIG. 10, since the interval in the circumferential direction between the plurality of poles 31 becomes narrowed by positioning the poles 31 on the forward side, any of the poles 31 and the moving units 32 may be thinned out.

The photographing apparatus 1A for photogrammetry according to the first modification has the following configuration.

(10) The photographing apparatus 1 for photogrammetry further includes the coupling section 34 that couples the plurality of poles 31.

The plurality of poles 31 are synchronized by the coupling section 34 to move by the plurality of moving units 32.

With this configuration, since the plurality of poles 31 can be moved in synchronization by the coupling section 34, the poles 31 can be moved efficiently as compared with the case where the poles 31 are individually moved.

The photographing apparatus 1A for photogrammetry according to the first modification has the following configuration.

(11) One end portions of the plurality of poles 31 are coupled to the coupling section 34, and the other end portions are coupled to the guide rail 33 (guiding unit) as a regulation member.

With this configuration, when the plurality of poles 31 are moved in synchronization by the coupling section 34 coupled to the upper end portions of the plurality of poles 31, the poles 31 move while the lower end portions of the poles 31 are guided by the guide rail 33. Therefore, since the pole 31 can be moved in a state where both upper and lower end portions of the poles 31 are regulated, the poles 31 can be stably moved in a state of being maintained in a predetermined attitude.

The photographing apparatus 1A for photogrammetry according to the first modification has the following configuration.

(12) The coupling section 34 includes

the plurality of rod-shaped portions 35 coupled to one end portions of the plurality of poles 31, and

the main portion 36 coupled to the end portions of the plurality of rod-shaped portions 35 on the side opposite to the side on which the poles 31 are coupled, and bundles the plurality of rod-shaped portions 35.

The coupling section 34 couples the plurality of poles 31 so as to be able to approach one another.

With this configuration, the photographing apparatus 1A for photogrammetry can be made compact in a coupled state by folding the plurality of poles 31 close to one another by the coupling section 34. Hence, the photographing apparatus 1A for photogrammetry can be easily transported.

Since the plurality of poles 31 can be bundled by the coupling section 34, handling of the plurality of poles 31 can be made easy without dispersing the poles 31.

### Second Modification

A photographing apparatus 1B for photogrammetry according to the second modification will be described.

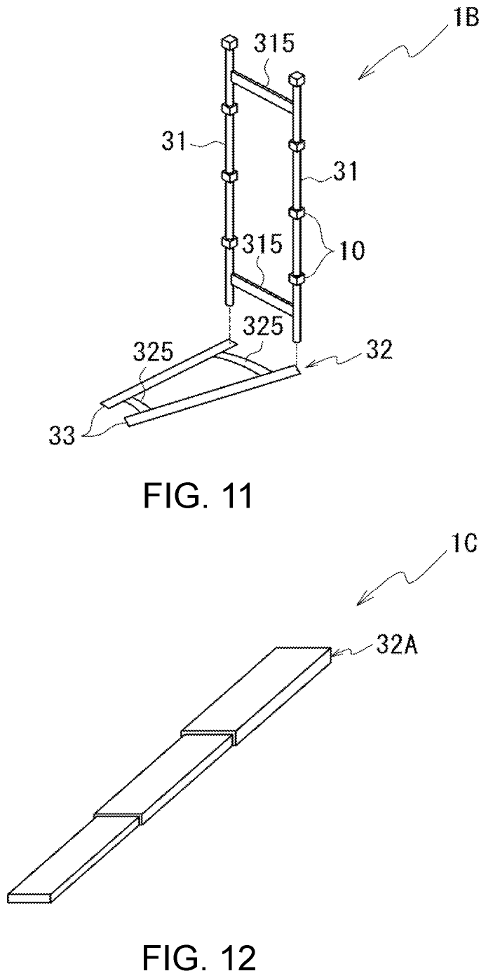

FIG. 11 is a view explaining the arrangement of the photographing device 10 in the photographing apparatus 1B for photogrammetry according to the second modification, and is a view explaining the periphery of the moving unit 32 and the poles 31.

Note that, in the following description, parts that are different from those of the photographing apparatus 1 for photogrammetry according to the present embodiment will be described, and the same parts will be described with the same reference numerals.

The photographing apparatus 1B for photogrammetry is provided with a connecting member 315 that connects the adjacent poles 31 and 31 between these poles 31 and 31. A plurality of the connecting members 315 are provided side by side in the longitudinal direction of the poles 31. The connecting member 315 is a foldable member, and is folded when the adjacent poles 31 and 31 are integrated, and is unfolded when the poles 31 and 31 are unintegrated.

Here, “the adjacent poles 31 and 31 are integrated” means that the adjacent poles 31 and 31 overlap each other by moving the poles 31 and 31 in a direction of approaching each other. In addition, “the poles 31 and 31 are unintegrated” means that the state where the poles 31 and 31 overlap is released by moving the poles 31 and 31 in a direction away from each other.

Between the adjacent moving units 32 and 32, a connecting member 325 that connects these moving units 32 and 32 is provided. A plurality of the connecting members 325 are provided side by side in the moving direction of the moving unit 32. Similarly to the connecting member 315, the connecting member 325 is a foldable member, and is folded when the adjacent moving units 32 and 32 are integrated, and is unfolded when the moving units 32 and 32 are unintegrated.

Here, “the adjacent moving units 32 and 32 are integrated” means that the adjacent moving units 32 and 32 overlap each other by moving the moving units 32 and 32 in a direction of approaching each other. In addition, “the moving units 32 and 32 are unintegrated” means that the state where the moving units 32 and 32 overlap is released by moving the moving units 32 and 32 in a direction away from each other.

As described above, according to the photographing apparatus 1B for photogrammetry according to the second modification, for example, as illustrated in FIG. 8, in a case where the target object to be photographed is small and it is necessary to thin any of the poles 31 and the moving units 32, it is possible to handle by overlapping and integrating the adjacent poles 31 and 31 and the moving units 32 and 32. Hence, the work is easier than detaching the pole 31 and the moving unit 32.

Note that, although detailed description is omitted, the connecting members 315 and 325 of the photographing apparatus 1B for photogrammetry according to the second modification can also be applied to the photographing apparatus 1A for photogrammetry according to the first modification.

### Third Modification

Next, a photographing apparatus 1C for photogrammetry according to the third modification will be described with reference to FIG. 12.

FIG. 12 is a view explaining a moving unit 32A of the photographing apparatus 1C for photogrammetry according to the third modification.

Note that, in the following description, parts that are different from those of the photographing apparatus 1 for photogrammetry according to the present embodiment will be described, and the same parts will be described with the same reference numerals.

The photographing apparatus 1C for photogrammetry according to the third modification has a structure in which the moving unit 32A is extendable in the moving direction of the pole 31. The moving unit 32A is, for example, a nested multistage slide rail. By being extended and contracted in the moving direction, the moving unit 32A can change the length of the path on which the pole 31 moves, and can change the moving range of the pole 31.

The photographing apparatus 1C for photogrammetry according to the third modification has the following configuration.

(13) The moving unit 32A can change the length of the path on which the pole 31 moves.

With this configuration, it is possible to change the moving range of the pole 31 by changing the length of the moving unit 32A according to the size of the target object. For example, when the target object is small, it is possible to narrow the moving range of the pole 31 by shortening the moving unit 32A in the direction of approaching the target object. This can make the size of the photographing apparatus 1C for photogrammetry compact.

Note that, although detailed description is omitted, the moving unit 32A of the photographing apparatus 1C for photogrammetry according to the third modification can also be applied to the photographing apparatus 1A for photogrammetry according to the first modification and the photographing apparatus 1B for photogrammetry according to the second modification.

### Shaping System 4

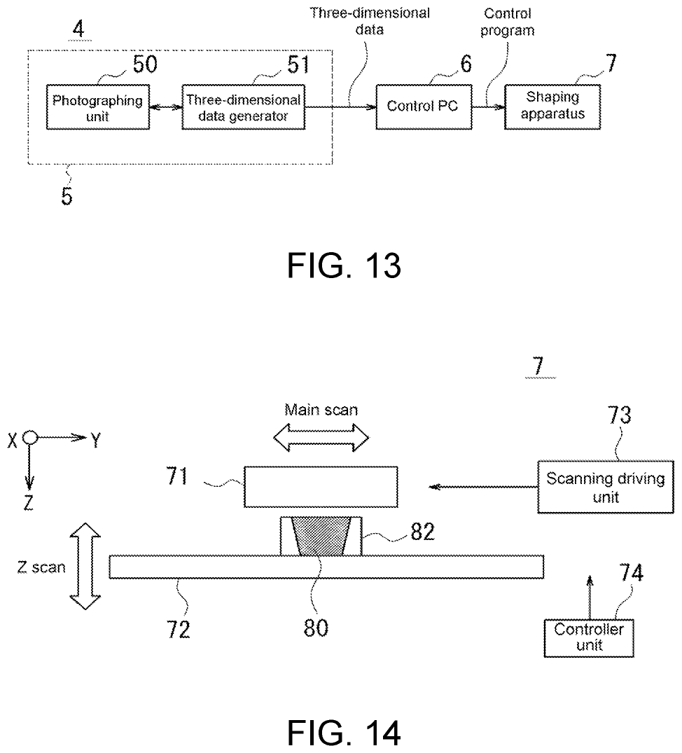

FIG. 13 is a view explaining a shaping system 4 according to the present embodiment.

The shaping system 4 is a system that reads the shape and color of a three-dimensional target object and shapes a three-dimensional shaped article, and includes a 3D scanner 5, a control PC 6, and a shaping apparatus 7. Note that the “target object” is a three-dimensional object used in the shaping system 4 as a target whose shape and color are to be read. The “three-dimensional shaped article” is a three-dimensional object shaped by the shaping system 4. The shaping apparatus 2 (see FIG. 5) may be applied to the shaping apparatus 7.

The 3D scanner 5 reads the three-dimensional shape of the target object and generates three-dimensional data. The control PC 6 converts the three-dimensional data into a control program for controlling the shaping apparatus 7. The shaping apparatus 7 executes the shaping of the three-dimensional shaped article based on the control program.

The 3D scanner 5 is communicably connected to the control PC 6. The control PC 6 is communicably connected to the shaping apparatus 7.

In the shaping system 4, the 3D scanner 5, the control PC 6, and the shaping apparatus 7 are configured as separate apparatuses. Note that in the shaping system 4, the 3D scanner 5, the control PC 6, and the shaping apparatus 7 may be configured by one apparatus.

### Shaping Apparatus

FIG. 14 is a schematic configuration view of the shaping apparatus 7.

As the shaping apparatus 7, a known shaping apparatus can be suitably used. For example, there is a shaping apparatus (3D printer) that shapes a three-dimensional shaped article by a layered shaping method using inks of a plurality of colors as a shaping material. The shaping apparatus 7 shapes a fully-colored three-dimensional shaped article by ejecting ink of each color by an inkjet head, for example. The layered shaping method is a method of shaping a three-dimensional shaped article by layering a plurality of layers, for example.

As shown in FIG. 14, the shaping apparatus 7 includes a head unit 71, a shaping table 72, a scanning driving unit 73, and a control unit 74.

The head unit 71 is a part that ejects the material of a three-dimensional shaped article 80. Examples of the material of the three-dimensional shaped article 80 include ink. Specifically, the ink is a liquid ejected from the inkjet head.

The head unit 71 ejects ink that cures under a predetermined condition from a plurality of inkjet heads as the material of the three-dimensional shaped article 80. Then, by curing the impacted ink, each layer constituting the three-dimensional shaped article 80 is formed in a layered manner, and the three-dimensional shaped article 80 is shaped by the layered shaping method. In this example, an ultraviolet-curable ink (UV ink), which cures from a liquid state by irradiation with ultraviolet, is used as the ink.

The head unit 71 further ejects the material of a support layer 82 in addition to the material of the three-dimensional shaped article 80. The shaping apparatus 7 forms the support layer 82 around the three-dimensional shaped article 80 as necessary. The support layer 82 is a layered structural object that supports the three-dimensional shaped article 80 by surrounding the outer periphery of the three-dimensional shaped article 80 during shaping, for example. The support layer 82 is shaped as necessary at the time of shaping of the three-dimensional shaped article 80, and is removed after the shaping is completed.

The shaping table 72 is a table-shaped member that supports the three-dimensional shaped article 80 during shaping, and is disposed at a position facing the inkjet head in the head unit 71. The three-dimensional shaped article 80 during shaping is placed on the upper surface. In this example, the shaping table 72 has a configuration in which at least the upper surface can move in the layering direction (Z direction in the figure), and when driven by the scanning driving unit 73, the shaping table 72 moves at least the upper surface in accordance with the progress of the shaping of the three-dimensional shaped article 80. In this case, the layering direction is a direction in which the shaping material is layered in the layered shaping method, for example. More specifically, in this example, the layering direction is a direction orthogonal to a main scanning direction (Y direction in the figure) and a sub scanning direction (X direction in the figure).

The scanning driving unit 73 is a driving unit that causes the head unit 71 to perform a scan of moving relatively to the three-dimensional shaped article 80 during shaping. In this case, moving relatively to the three-dimensional shaped article 80 during shaping means moving relatively to the shaping table 72, for example. Causing the head unit 71 to perform a scan means causing the inkjet head of the head unit 71, for example, to perform a scan. In this example, the scanning driving unit 73 causes the head unit 71 to perform a main scan (Y scan), a sub scan (X scan), and a layering direction scan (Z scan).

The main scan is an operation of ejecting ink while moving in the main scanning direction. The scanning driving unit 73 causes the head unit 71 to perform the main scan by fixing the position of the shaping table 72 in the main scanning direction and moving the head unit 71 side. The scanning driving unit 73 may move the three-dimensional shaped article 80 side by fixing the position of the head unit 71 in the main scanning direction and moving the shaping table 72.

The sub scan is an operation of moving relatively to the shaping table 72 in a sub scanning direction orthogonal to the main scanning direction. The sub scan is an operation of moving relatively to the shaping table 72 in the sub scanning direction by a feeding amount set in advance.

The scanning driving unit 73 causes the head unit 71 to perform the sub scan by fixing the position of the head unit 71 in the sub scanning direction between the main scan and moving the shaping table 72. Note that the scanning driving unit 73 may cause the head unit 71 to perform the sub scan by fixing the position of the shaping table 72 in the sub scanning direction and moving the head unit 71.

The layering direction scan is an operation of moving the head unit 71 in the layering direction relatively to the three-dimensional shaped article 80 by moving at least one of the head unit 71 and the shaping table 72 in the layering direction.

The scanning driving unit 73 adjusts the relative position of the inkjet head with respect to the three-dimensional shaped article 80 during shaping in the layering direction by causing the head unit 71 to perform the layering direction scan in accordance with the progress of the shaping operation.

The scanning driving unit 73 fixes the position of the head unit 71 in the layering direction and moves the shaping table 72. The scanning driving unit 73 may fix the position of the shaping table 72 in the layering direction and move the head unit 71.

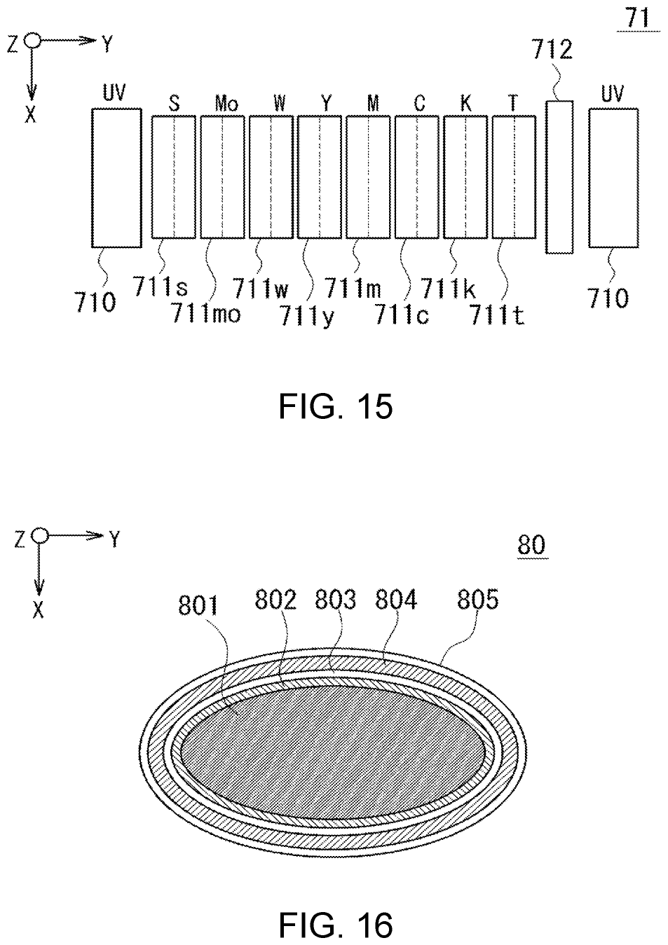

FIG. 15 is a view explaining the head unit 71 in the shaping apparatus 7.

The head unit 71 includes a plurality of inkjet heads, a plurality of ultraviolet light sources 710, and a flattening roller 712.

The head unit 71 has the plurality of inkjet heads including an inkjet head 711s, an inkjet head 711mo, an inkjet head 711w, an inkjet head 711y, an inkjet head 711m, an inkjet head 711c, an inkjet head 711k, and an inkjet head 711t.

The plurality of inkjet heads are arranged side by side in the main scanning direction with the position in the sub scanning direction being aligned. Each inkjet head has a nozzle row in which a plurality of nozzles are arranged side by side in a predetermined nozzle row direction on a surface facing the shaping table 72. The nozzle row direction is a direction parallel to the sub scanning direction.

The inkjet head 711s is an inkjet head that ejects the material of the support layer 82. As the material of the support layer 82, a known material for the support layer can be suitably used. The inkjet head 711 is an inkjet head that ejects a shaping material ink (Mo ink). The shaping material ink is an ink dedicated to shaping used for the shaping of the interior (inner region) of the three-dimensional shaped article 80.

The interior of the three-dimensional shaped article 80 is not limited to the shaping material ink, and may be formed further using an ink of another color. It is considered to form the interior of the three-dimensional shaped article 80 only with the ink of another color (for example, white ink and the like) without using the shaping material ink. In this case, the inkjet head 711mo may be omitted in the head unit 71.

The inkjet head 711w is an inkjet head that ejects a white (W color) ink. The white ink is an example of a light reflective ink, and is used when forming a region (light reflecting region) having a property of reflecting light in the three-dimensional shaped article 80, for example.

The inkjet head 711y, the inkjet head 711m, the inkjet head 711c, and the inkjet head 711k (hereinafter referred to as the inkjet heads 711y to 711k) are coloring inkjet heads used at the time of shaping the colored three-dimensional shaped article 80.

The inkjet head 711y ejects a yellow (Y color) ink. The inkjet head 711m ejects a magenta (M color) ink. The inkjet head 711c ejects a cyan (C color) ink. The inkjet head 711k ejects a black (K color) ink.

Each color of YMCK is an example of a process color used for full color representation by the subtractive color mixing method. The ink of each color is an example of a colored material for coloring.

The inkjet head 711t is an inkjet head that ejects a clear ink. The clear ink is a clear ink in a colorless, transparent color (T), for example.

The plurality of ultraviolet light sources 710 are light sources (UV light sources) for curing the ink, and generate ultraviolet that cures the ultraviolet-curable ink. Each of the plurality of ultraviolet light sources 710 is disposed on each of one end side and the other end side in the main scanning direction in the head unit 71 so as to place the array of the inkjet heads in between. As the ultraviolet light source 710, for example, an ultraviolet LED (UV LED) or the like can be suitably used. A metal halide lamp, a mercury lamp, or the like may be used as the ultraviolet light source 710.

The flattening roller 712 is a flattening means for flattening a layer of the ink formed during shaping of the three-dimensional shaped article 80. The flattening roller 712 flattens the layer of ink by coming into contact with the surface of the layer of ink and removing a part of the ink before curing at the time of the main scan, for example.

By using the head unit 71 having the above-described configuration, it is possible to appropriately form the layer of ink constituting the three-dimensional shaped article 80. By forming a plurality of layers of ink in a layer, it is possible to appropriately shape the three-dimensional shaped article 80.

The head unit 71 may further include an inkjet head for a color other than the above as a coloring inkjet head. The arrangement of the plurality of inkjet heads in the head unit 71 can also be variously modified. For example, the position of some inkjet heads in the sub scanning direction may be shifted from the other inkjet heads (for example, a staggered arrangement is adopted).

FIG. 16 is a view explaining the three-dimensional shaped article 80 shaped by the shaping apparatus 7. FIG. 16 is a schematic view of a cut surface on which the three-dimensional shaped article 80 is cut with an X-Y plane perpendicular to the Z direction.

In the case of shaping the three-dimensional shaped article 80 with a colored surface, coloring the surface of the three-dimensional shaped article 80 means coloring at least a part of a region of the three-dimensional shaped article 80 where hue can be visually recognized from the outside, for example.

Then, the shaping apparatus 7 shapes the three-dimensional shaped article 80 including an inner region 801, a light reflecting region 802, a separation region 803, a region 804 to be colored, and a protection region 805.

The inner region 801 is a region constituting the interior of the three-dimensional shaped article 80. The inner region 801 can also be considered as a region (shaping region) constituting the shape of the three-dimensional shaped article 80, for example. In this example, the head unit 71 forms the inner region 801 using the shaping material ink ejected from the inkjet head 711mo.

The light reflecting region 802 is a region for reflecting light entering from the outside of the three-dimensional shaped article 80 via the region 804 to be colored and the like. The head unit 71 forms the light reflecting region 802 around the inner region 801 using the white ink ejected from the inkjet head 711w.

The separation region 803 is a transparent region (transparent layer) for preventing the ink constituting the light reflecting region 802 and the ink constituting the region 804 to be colored from mixing each other. In this example, the head unit 71 forms the separation region 803 around the light reflecting region 802 using the clear ink ejected from the inkjet head 711t.

The region 804 to be colored is a region colored with the coloring ink ejected from the inkjet heads 711y to k. In this case, the coloring ink is an example of the coloring material. In this example, the head unit 71 forms the region 804 to be colored around the separation region 803 using the coloring ink ejected from the inkjet heads 711y to k and the clear ink ejected from the inkjet head 711t. Due to this, the region 804 to be colored is formed outside the inner region 801 and the like. In this case, various colors are expressed by adjusting the ejection amount of the coloring ink of each color to each position, for example. The clear ink is used in order to compensate the change in the amount of coloring ink (ejection amount per unit volume is 0% to 100%) caused by the difference in color to a constant 100%. This enables each position of the region 158 to be colored to be appropriately colored with a desired color.

The protection region 805 is a transparent region (outer transparent region) for protecting the outer surface of the three-dimensional shaped article 80. In this example, using the clear ink ejected from the inkjet head 711t, the head unit 71 forms the protection region 805 around the region 804 to be colored. Due to this, using a transparent material, the head unit 71 forms the protection region 805 so as to cover the outside of the region 804 to be colored. By forming each region as described above, it is possible to appropriately form the three-dimensional shaped article 80 with a colored surface.

Note that as a modification of the configuration of the three-dimensional shaped article 80, the inner region 801 also having the function of the light reflecting region 802 may be formed using, for example, a white ink without distinguishing the inner region 801 and the light reflecting region 802. The separation region 803, the region 804 to be colored, and the like may be omitted.

The control unit 74 is a CPU included in the shaping apparatus 7. The control unit 74 controls the operation of shaping of the three-dimensional shaped article 80 by controlling each unit of the shaping apparatus 7.

The control unit 74 controls each unit of the shaping apparatus 7 based on the control program received from the control PC 6.

### Control PC

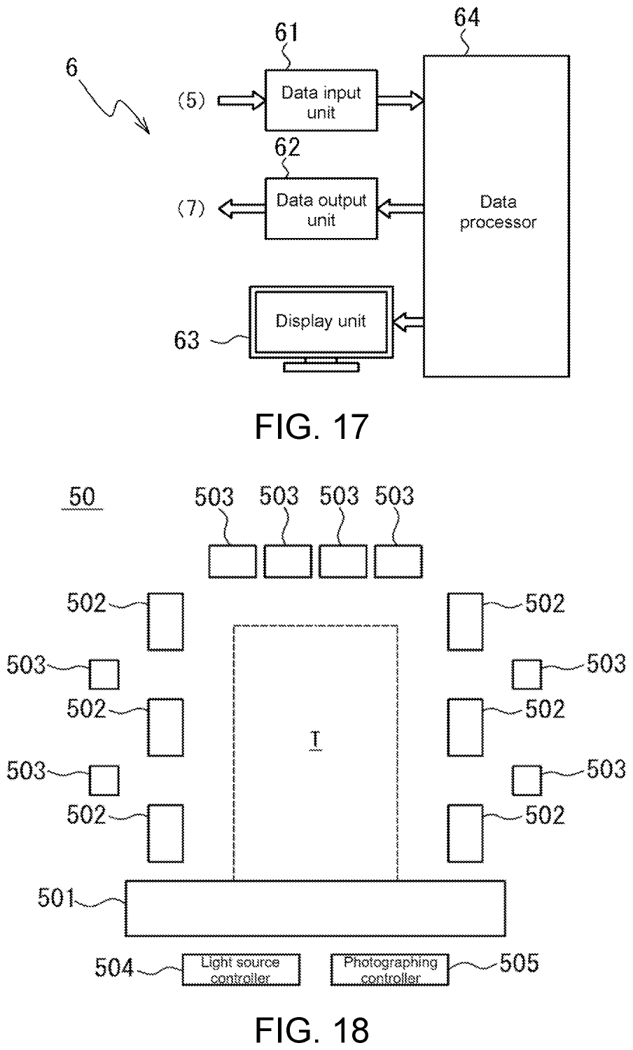

FIG. 17 is a functional block diagram of the control PC 6.

FIG. 17 illustrates various functions of the control PC 6 divided into blocks in order to explain functional features. Therefore, each block does not necessarily correspond to the physical configuration (for example, a unit of an electronic circuit or the like) in the control PC 6.

The control PC 6 includes a data input unit 61, a data output unit 62, a display unit 63, and a data processor 64.

The data input unit 61 receives input of three-dimensional data supplied from an apparatus outside the control PC 6 such as the 3D scanner 5. The data input unit 61 receives input of three-dimensional data via, for example, a communication path such as the Internet or a storage medium such as a memory card.

The data processor 64 performs processing of converting the three-dimensional data received from the 3D scanner 5 into information for controlling the shaping apparatus 7. Specifically, the data processor 64 converts the three-dimensional data into a control program for controlling the inkjet printer.

The data output unit 62 outputs the control program created by the data processor 64 to the shaping apparatus 7. The data output unit 62 outputs the control program to the shaping apparatus 7 via, for example, a communication path or a storage medium.

Thus, the three-dimensional data generated by the 3D scanner 5 is converted into a predetermined format by the control PC 6 and supplied to the shaping apparatus 7.

### 3D Scanner

Generation of three-dimensional data using the 3D scanner 5 according to the present embodiment will be described below.

The 3D scanner 5 is an example of a three-dimensional data generation apparatus, and captures an image of (photographs) a target object and reads a three-dimensional shape and color of the target object. The 3D scanner 5 can also be considered as an example of a three-dimensional data generation system, for example. The “color of the target object” is the color of the surface of the target object. The “surface of the target object” is a region of the target object where hue can be visually recognized from the outside. As the three-dimensional data, for example, data of a format same as or similar to the format of known data used as data indicating a three-dimensional shaped article can be suitably used.

As shown in FIG. 13, the 3D scanner 5 includes a photographing unit 50 and a three-dimensional data generator 51. The photographing unit 50 is an apparatus that photographs the target object from a plurality of viewpoints and acquires a plurality of images (camera images) of the target object. The three-dimensional data generator 51 generates three-dimensional data indicating the shape and color of the target object based on the plurality of images acquired by the photographing unit 50. The three-dimensional data generator 51 generates three-dimensional data using the method described in the photographing apparatus 1 for photogrammetry of the embodiment, for example. In this case, the photogrammetry method can be considered as a method of photographic measurement in which the dimensions and shape are obtained by analyzing parallax information from two-dimensional images obtained by photographing the target object from a plurality of observation points, for example. As the three-dimensional data generator 51, a computer or the like that operates according to a predetermined program can be suitably used.

FIG. 18 is a view explaining the photographing unit 50 of the 3D scanner 5. In FIG. 18, a target object T is indicated by an imaginary line.

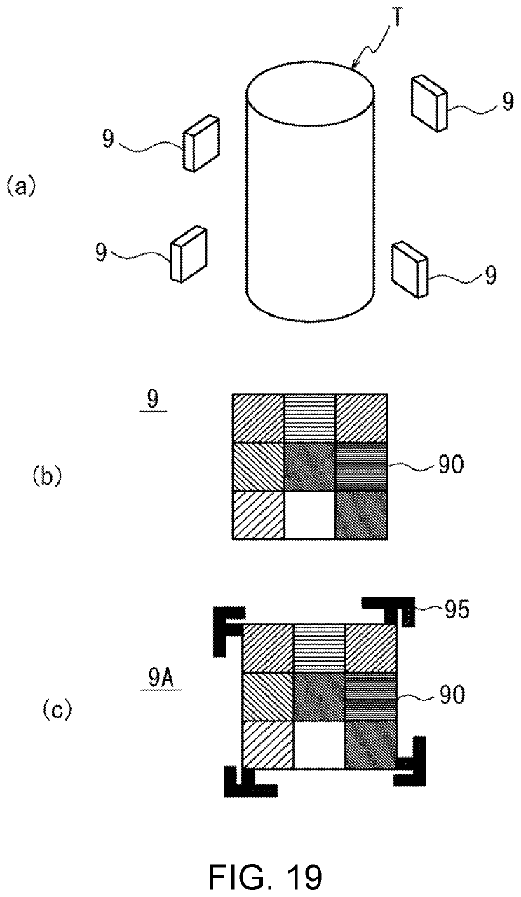

FIG. 19 is a view explaining a color target 9. (a) is a view showing the arrangement of the color target 9 with respect to the target object T. (b) is a view explaining a patch portion 302 of the color target 9. (c) is a view explaining a color target 9A according to a modification.

As shown in FIG. 18, the photographing unit 50 includes a stage 501, a plurality of cameras 502, a plurality of light sources 503, a light source controller 504, and a photographing controller 505.

The stage 501 is a table on which the target object T is placed. On the stage 501, in addition to the target object T, the color target 9 is installed as a color sample (see (a) of FIG. 19). The color target 9 will be described later.

The plurality of cameras 502 are photographing apparatuses that photograph the target object T. The plurality of cameras 502 are installed at different positions from one another to photograph the target object from different viewpoints from one another. Thus, images of the target object T viewed from different viewpoints are acquired. In this case, the plurality of cameras 502 may be arranged by applying, for example, the above-described photographing apparatus 1 to 1C for photogrammetry (see FIGS. 7 to 12).

The plurality of cameras 502 are installed at different positions from one another on a horizontal plane or in a vertical direction so as to surround the periphery of the stage 501, thereby photographing the target object T from different positions from one another.

Each of the plurality of cameras 502 photographs the target object T placed on the stage 501 from each position surrounding the periphery of the target object T.

Each camera 502 photographs the target object T so as to at least partially overlap with images acquired by the other cameras 502. In this case, at least partially overlapping with an image photographed by the camera 502 means overlapping the visual fields of the plurality of cameras 502 with one another.

In accordance with control of the photographing controller 505, the plurality of cameras 502 perform photographing for the purpose of adjustment of the light source 503 and photographing (actual photographing) for performing final reading.

Here, “adjustment of the light source 503” means adjustment of the light quantity. The “actual photographing” is photographing for acquiring an image to be used for generation of three-dimensional data by the three-dimensional data generator 51.

The image acquired by the camera 502 is a color image. In this case, the color image is, for example, an image (e.g., full-color image) in which a component of a color corresponding to a predetermined basic color (e.g., each color of RGB) is expressed by a plurality of levels of gradation. As the plurality of images acquired by the camera 502 in actual photographing, for example, it is conceivable to use an image same as or similar to an image used by a known 3D scanner or the like. The image used by a known 3D scanner or the like is, for example, a plurality of images used when the shape of the target object is estimated by the photogrammetry method or the like. Also at the time of photographing for the purpose of adjustment of the light source 503, images in the same format as those at the time of actual photographing are acquired by the plurality of cameras 502.

Note that the format of the images acquired by the plurality of cameras 502 at the time of photographing for the purpose of adjustment of the light source 503 may be varied from that at the time of actual photographing. For example, it is conceivable to vary the resolution of the image, the setting of the photographing condition in the camera 502, and the like. This is because photographing can be performed under conditions suitable at the time of each photographing.

As shown in FIG. 18, the plurality of light sources 503 are illumination apparatuses that irradiate the target object T with light. Each of the plurality of light sources 503 irradiates the target object T with light according to the control of the photographing controller 505. As each of the plurality of light sources 503, a known high color rendering light source (for example, a D50 light source, a D65 light source, or the like) can be suitably used.

The light source controller 504 controls the operation of the plurality of light sources 503. The light source controller 504 determines an irradiation setting indicating the manner of light irradiation at the time of actual photographing based on an image obtained by photographing for the purpose of adjustment of the light source 503. At the time of actual photographing, the operation of the light source 503 is controlled based on the irradiation setting.

The photographing controller 505 controls the operation of the plurality of cameras 502. The photographing controller 505 causes the plurality of cameras 502 to perform photographing for the purpose of adjustment of the light source 503 and actual photographing for performing final reading.

As illustrated in (a) of FIG. 19, not only the target object T but also the color target 9 is placed on the stage 501 (see FIG. 18) of the photographing unit 50. The plurality of images obtained by photographing the target object T by the photographing unit 50 are images and the like acquired in a state where the color target 9 is installed around the target object T.

Both at the time of photographing for the purpose of adjustment of the light source 503 and at the time of actual photographing for performing final reading, a plurality of photographing is performed in a state where the plurality of color targets 9 are installed around the target object T as illustrated in (a) of FIG. 19.

Each of the plurality of color targets 9 is placed at a discretionary position around the target object 50. In this case, the plurality of color targets 9 are installed so as to surround the target object T. Each color target 9 is placed at any position in the photographing environment (e.g., an environment background, a floor, and the like) so as to be photographed by any of the plurality of cameras 502 (see FIG. 18).

This makes it possible to acquire a plurality of images in which each color target 9 appears in any image as a plurality of images acquired by the photographing unit 50.

It is considered that at least some of the plurality of color targets 9 are placed, for example, at a part of the target object 50 where color is important or at a position where the way the color is seen is liable to change due to the influence of the way light illuminates. In this case, the part of the target object 50 where color is important is a part where color reproduction is important when shaping a three-dimensional shaped article that represents the target object 50, for example.

The color target 9 is an example of a color sample indicating a preset color. As the color target 9, for example, a color chart indicating a plurality of preset colors can be suitably used. As such a color chart, a color chart same as or similar to a commercially-available, known color chart can be suitably used. The color target 9 can also be considered as a color sample indicating a plurality of predetermined colors, for example.

As shown in (b) of FIG. 19, the color target 9 has a patch portion 90 including a plurality of color patches indicating different colors from one another. In this case, the patch portion 90 can also be considered as a part constituting a color chart in the color target 9, for example. Note that, for convenience of illustration, (b) of FIG. 19 indicates a plurality of color patches having different color from one another by expressing the difference in color by the difference in shading pattern for the nine types of colors. The patch portion 90 can also be considered as a part indicating a predetermined color in the color target 9, for example. As the color chart, a chart indicating more colors may be used.

As shown in (c) of FIG. 19, the color target 9A may further include a configuration other than the patch portion 90. Specifically, the color target 9A further includes a plurality of markers 95 in addition to the patch portion 90. The plurality of markers 95 are members (marker portions) used for discriminating the color target 9, and are installed around the patch portion 90.

Each of the plurality of markers 95 is an example of the discrimination portion indicative of being the color target 9. As the marker 95, for example, a marker same as or similar to a known marker (image discrimination marker) used for image discrimination may be used.

Each of the plurality of markers 95 has a predetermined same shape, and is attached to a position of each of the four corners of the quadrilateral patch portion 90 with different orientations from one another.

By using such the marker 95, it is possible to appropriately detect the color target 9 with high accuracy using the marker 95 as a mark.

The operation of generating three-dimensional data, such as description of timing of photographing by the camera 502 and description of how to use the color target 9, will be described below.

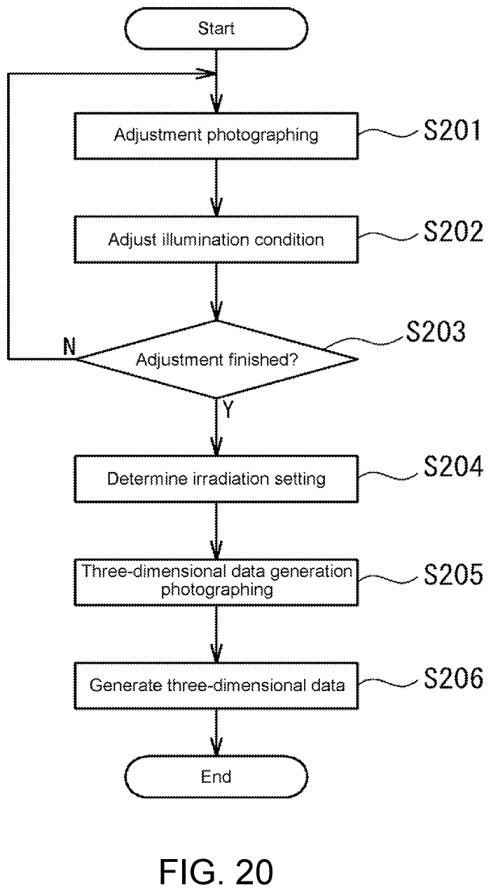

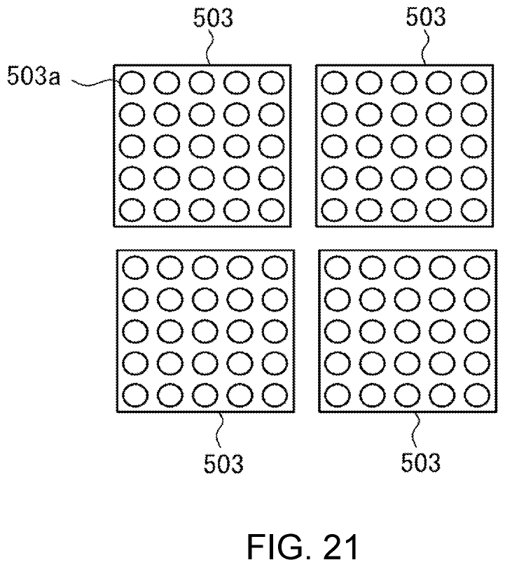

FIG. 20 is a flowchart illustrating an example of the operation of generating three-dimensional data.

When generating three-dimensional data by the 3D scanner 5, first, the photographing unit 50 photographs the target object T (see (a) of FIG. 19). As photographing for the target object T, photographing for the purpose of adjustment of the light source 503 and actual photographing for performing final reading are performed.

As illustrated in the flowchart of FIG. 20, first, the photographing controller 505 in the photographing unit 50 causes the plurality of cameras 502 to perform photographing (adjustment photographing) of the target object T for the purpose of adjustment of the light source 503 (step S201). The image acquired by the camera 502 at this time is an image (hereinafter referred to as a light source adjustment image) used for adjusting the light quantity of the light source 503.

In this case, the operation of step S201 is repeated a plurality of times as necessary. In this case, in the operation of step S201 of each time, the light source controller 504 causes the plurality of light sources 503 to emit light based on the illumination condition set in advance.

Here, in step S201 executed for the first time, the illumination condition is set to a preset initial value.

Following the operation of step S201, the illumination condition is adjusted (step S202). The light source controller 504 detects how light illuminates the target object T based on how the color target 9 appears in the light source adjustment image acquired in step S201. Then, as necessary, the illumination condition is adjusted so as to bring the manner of light illumination close to a desired state by changing the intensity of the light emitted by each light source 503, for example.

After the illumination condition is adjusted in step S202, it is determined whether or not the adjustment is finished (step S203), and if it is determined that the adjustment is finished (step S203: Yes), the process proceeds to the next step S204.

For example, if it is determined that the illumination condition under which how light illuminates the target object T becomes a desired state has been successfully set in step S201, it is determined that the adjustment of the illumination condition is finished. Specifically, if the adjustment amount of the illumination condition performed in step S201 is smaller than the preset upper limit value, it is determined that the adjustment of the illumination condition is finished.

If the adjustment amount of the illumination condition performed in step S201, for example, is large, it is determined that the adjustment of the illumination condition is not completed (step S203: No), and the operations in and after step S201 are repeated. In this case, in step S201 executed for the second time and subsequent times, the illumination condition after the adjustment in step S202 performed immediately before is used as the illumination condition.

Thus, it is possible to set the illumination condition so as to bring how light illuminates the target object T close to a desired state.

When the number of repetitions of the operations in steps S201 to S203 reaches the predetermined upper limit, it is determined in step 203 that the adjustment of the illumination condition is finished. When the number of repetitions reaches the upper limit, the operation of generating three-dimensional data is stopped, and a user instruction is received.

When the adjustment of the illumination condition is finished, irradiation setting used at the time of actual photographing is determined (step S204). The irradiation setting is a setting of a manner of irradiating the plurality of light sources 503 with light at the time of actual photographing. In this example, the light source controller 504 uses, as the irradiation setting, the setting corresponding to the illumination condition after the adjustment in step S202 performed immediately before. Thus, it is possible to appropriately determine the irradiation setting to irradiate the target object T with light in a desired state.

In this case, the operation of determining the irradiation setting in the light source controller 504 can be considered as an operation of determining the irradiation setting based on the color target 9 appearing in the light source adjustment image, for example. In this example, determining the irradiation setting based on the color targets 9 appearing in the light source adjustment image means determining the irradiation setting indicating the manner of light irradiation by each of the plurality of light sources 503 based on the color targets 9 appearing in a plurality of light source adjustment images. This makes it possible to more appropriately determine the irradiation setting in which each portion of the target object T is more appropriately irradiated with light.

Then, after the irradiation setting is determined, actual photographing (three-dimensional data generation photographing) for acquiring an image to be used for generation of three-dimensional data is executed (step S205). Specifically, in step S205, the light source controller 504 causes the plurality of light sources 503 to irradiate the target object T with light based on the irradiation setting determined in step S204.

Then, in a state where the light irradiation based on the irradiation setting is performed, the photographing controller 505 causes the plurality of cameras 502 to photograph the target object T. The image acquired by the camera 502 at this time is an image (hereinafter, referred to as a three-dimensional data generation image) used for generating three-dimensional data in the three-dimensional data generator 51.

In this example, the color target 9 is also used at the time of acquiring the three-dimensional data generation image. In this case, in a state where the plurality of color targets 9 are installed around the target object T (see (a) of FIG. 19), the photographing controller 505 causes the plurality of cameras 502 to photograph the target object T from a plurality of different viewpoints from one another to acquire a plurality of three-dimensional data generation images. In this case, it is conceivable to set the positions where the plurality of color targets 9 are installed to be the same as those at the time of acquiring the light source adjustment image. Thus, acquisition of the light source adjustment image and acquisition of the three-dimensional data generation image can be appropriately performed continuously without changing the positions of the target object T and the plurality of color targets 9.

In a modification of the operation of generating three-dimensional data, the positions at which the plurality of color targets 9 are installed may be different between the time of acquiring the light source adjustment image and the time of acquiring the three-dimensional data generation image. This allows the plurality of color targets 9 to be installed at positions more suitable for each photographing purpose.

After acquiring the three-dimensional data generation image, the three-dimensional data generator 51 generates three-dimensional data indicating the shape and color of the target object T based on the plurality of three-dimensional data generation images acquired by the plurality of cameras 502 (step S206). In this example, the three-dimensional data generator 51 performs color adjustment on the three-dimensional data generation image based on the color target appearing in the three-dimensional data generation image. In this case, performing color adjustment on the three-dimensional data generation image means performing color matching or the like based on the color of the color target 9 appearing in the three-dimensional data generation image, for example. This allows color adjustment to be more appropriately performed at the time of generating the three-dimensional data. It is possible to generate three-dimensional data more appropriately with higher accuracy.

Thus, photographing of the target object T by the photographing unit 50 is performed in a state where the color target 9 is installed around the target object T. By using the plurality of light source adjustment images acquired at this time, it is possible to appropriately detect how light illuminates the target object T. By adjusting the illumination condition based on this detection result, it is possible to bring how light illuminates the target object T close to a desired condition. Therefore, it is possible to appropriately adjust the manner of light irradiation at the time of acquiring a three-dimensional data generation image. At the time of generating three-dimensional data, it is possible to appropriately detect the color of the target object T with higher accuracy, and to appropriately perform generation of the three-dimensional data with higher accuracy.

In this example, by repeating the operations of steps S201 to S203 as necessary, when the light source adjustment image is acquired, the target object T is photographed a plurality of times by the camera 502 while the manner of light irradiation by the plurality of light sources 503 is varied. Specifically, photographing of the target object T and adjustment of the light irradiation manner are repeated so as to adjust the light irradiation manner based on the light source adjustment image every time the target object T is photographed. This makes it possible to more appropriately determine the irradiation setting close to the desired light irradiation manner.

In this example, by using the plurality of light sources 503, the target object T is irradiated with light from a plurality of directions. At the time of acquiring the three-dimensional data generation image, the light source controller 504 causes the plurality of light sources 503 to irradiate the target object T with light based on the irradiation setting. In this case, by controlling each light source 503 based on the irradiation setting, the light irradiation manner from each direction can be variously changed. Therefore, at the time of acquiring three-dimensional data generation image, the target object T can be appropriately irradiated with light.

In this example, the plurality of color targets 9 are installed at different positions from one another around the target object T. Then, in a state where the plurality of color targets 9 are installed at different positions from one another around the target object T, the photographing controller 505 causes the plurality of cameras 502 to acquire photographing of the light source adjustment image. This makes it possible to more appropriately detect how light illuminates various portions of the target object T.

The light source controller 504 detects how light illuminates each portion of the target object T based on each color target 9 appearing in the light source adjustment image. Then, the light source controller 504 determines the irradiation setting based on the detected manner of light illumination.

This makes it possible to appropriately determine the irradiation setting in consideration of how light illuminates each portion of the target object T. It is possible to cause the three-dimensional data generation image to be acquired in a state where each portion of the target object T is irradiated with light more uniformly.

Regarding the irradiation setting, it is conceivable to determine the irradiation setting such that more light is irradiated to a portion (shadow part) where light irradiation is insufficient at the time of acquiring the light source adjustment image. In this case, the light source controller 504 detects a portion of the target object T with insufficient light illumination based on each color target 9 appearing in the light source adjustment image. Then, the light source controller 504 determines the irradiation setting so that a portion with insufficient light illumination is irradiated with more light than light at the time of acquiring the light source adjustment image. This makes it possible to more appropriately irradiate the target object T with light, and hence it is possible to acquire an appropriate three-dimensional data generation image.

Here, in a case of detecting a portion with insufficient light illumination in the target object T, it is conceivable to use a photometer or the like, for example. However, the detection result may vary depending on the color difference of the target object T.

For example, in a case where a part of the target object T that is in a contractive color such as black is irradiated with light, even if light is appropriately emitted, there is a risk of being determined that light irradiation is insufficient (shadow is formed) by the photometer. On the other hand, the color target 9 can determine whether or not the light quantity is insufficient after grasping that the color is a contractive color. Hence, by using the color target 9, it is possible to obtain a more reliable detection result than that by the photometer.

FIG. 21 is a view illustrating the light source 503.

Light emitted from the plurality of light sources 503 is controlled by the light source controller 504 (see FIG. 18). In this case, as the light source 503, it is preferable to use a configuration in which light irradiation can be easily controlled. As each of the plurality of light sources 503, an LED array or the like in which a plurality of LEDs 503a are arranged can be suitably used. In this case, each light source 503 can be considered as a light source in which the plurality of LEDs 503a are arranged.

By varying the light emission intensity of each LED 503a, it is possible to adjust the light quantity of the light emitted from the light source 503 to the target object T. By arranging the plurality of light sources 503 at different positions, it is possible to variously change the light quantity or the like of the light emitted to the target object T from each of the plurality of directions.

This makes it possible to easily and appropriately perform adjustment and the like of the light emitted from each light source 503.

In a case where an LED array is used as the light source 503, it is conceivable that the control of the light source 503 by the light source controller 504 is performed in units of the light source 503 including the plurality of LEDs 503a. This makes it possible to more easily perform the control even when a large number of LEDs 503a are used. In a case where more detailed control is intended, it is also conceivable that the light source controller 504 individually controls each LED 503a constituting the LED array. In this case, each LED 503a can also be considered as one light source 503 or the like.

As the plurality of light sources 503, it is conceivable to use light sources having the same characteristics, for example. The light source having the same characteristic is, for example, a light source manufactured as the same component with the same specifications. In a case of performing more various control on the light with which the target object T is irradiated, a light source having characteristics different from those of the other light sources 503 may be used as a part of the plurality of light sources 503. In this case, as the plurality of light sources 503, it is conceivable to use a plurality of light sources having different color rendering indices, for example. Specifically, it is considered to use the light source 503 (for example, D50 light source) having the first color rendering index as a part of the plurality of light sources 503 included in the photographing unit 50, and use the light source 503 (for example, D65 light source) having the second color rendering index as another part of the plurality of light sources 503. Thus, the color rendering indices obtained by the plurality of light sources 503 can be variously changed by adjusting the manner of light irradiation by each light source 503. At the time of acquiring the three-dimensional data generation image, it is possible to more variously change the manner of irradiating the target object T with light.

Subsequently, a supplementary explanation regarding each configuration described above and explanations on modifications will be given. In this example, by adjusting the illumination condition based on the light source adjustment image, the irradiation setting to be used at the time of acquiring the three-dimensional data generation image is determined. In this case, it is preferable to determine the irradiation setting corresponding to the illumination condition adjusted so that the light illuminates each position of the target object T with a constant illuminance, for example. However, it is difficult to completely uniform the illuminance. Depending on the shape or the like of the target object T, there may be a case where a difference remains in the manner of light illumination depending on the position even after the illumination condition is adjusted.

Therefore, in this example, by using the color target 9 also at the time of acquiring the three-dimensional data generation image, color adjustment (correction) such as color matching is performed on the three-dimensional data generation image as necessary at the time of generating the three-dimensional data. Therefore, since the color of the target object T can be more appropriately read based on the three-dimensional data generation image, three-dimensional data indicating the color of the target object T with higher accuracy can be appropriately generated. Even if a shadow part occurs in a part of the target object T in three-dimensional data generation image, color adjustment or the like for removing its influence can be appropriately performed.

In a case where the 3D scanner 5 reads the color of the target object T, it is considered that a difference occurs in the way the color is seen as compared with other environments (for example, an environment exposed to sunlight) due to the characteristics of the light source 503 and the like. Therefore, in order to read the color with high accuracy by the 3D scanner 5, it is preferable to perform color adjustment by discriminating under what environment the color has been acquired. In a case where the reading result by the 3D scanner 5 is confirmed by, for example, a monitor of a computer, it is conceivable that a difference occurs in the way the color is seen due to characteristics of the monitor.

Therefore, in this example, in a state where the color target 9 is installed around the target object T, the target object T is photographed by the camera 502, a three-dimensional data generation image is acquired, and the color is adjusted based on the color target appearing in the three-dimensional data generation image. This makes it possible to discriminate under what environment the color of each portion of the target object T appearing in the three-dimensional data generation image has been acquired. It is also possible to appropriately perform color management or the like for removing environmental factors. By appropriately performing color management and the like, it is also possible to appropriately adjust the color displayed on the monitor or the like of the computer, for example.

Regarding such color adjustment, it is conceivable to perform adjustment so that the patch portion 90 (see (b) of FIG. 19) of each color in the color target 9 appearing in the three-dimensional data generation image becomes the original color. In this case, for the plurality of color targets 9 installed around the target object T, the adjustment values are different according to the difference in the manner of illumination of the light from the plurality of light sources 503. Then, the color of each portion of the target object T can be adjusted in accordance with the way the color is seen of any color target 9 (for example, the closest color target 9). The color adjustment can be performed by normalizing the difference in the way the color is seen for each position (for each place) based on the way the color is seen of each of the plurality of color targets 9 and determining the correction amount for each position. For the shadow part, the influence of the shadow can be appropriately removed by determining the color correction amount according to the intensity of the shadow, for example.

By performing the color adjustment as described above, the color of each portion of the target object T appearing in each three-dimensional data generation image can be appropriately adjusted.

By controlling the plurality of light sources 503 based on the irradiation setting, the light irradiation manner from the plurality of light sources 503 can be treated as known information. In this case, the color adjustment as described above can be more easily and appropriately performed.

At the time of acquiring each of the light source adjustment image and the three-dimensional data generation image, the plurality of cameras 502 acquire a plurality of images. In this case, regarding the number of images to be acquired, it is conceivable to make the number of light source adjustment images and the number of three-dimensional data generation images the same. However, in a modification of the operation of generating three-dimensional data, the number of light source adjustment images and the number of three-dimensional data generation images may be different for the number of images to be acquired. In this case, the number of light source adjustment images is, for example, the number of light source adjustment images substantially used at the time of determining the irradiation setting. The number of three-dimensional data generation images is, for example, the number of three-dimensional data generation images substantially used at the time of generating the three-dimensional data.

More specifically, the processing of generating three-dimensional data by the three-dimensional data generator 51 can be considered as processing of performing many image processing and the like. Therefore, if the number of three-dimensional data generation images is too large, it is conceivable that, for example, burden on data processing increases, and a lot of time is required for the processing. On the other hand, regarding the processing of determining the irradiation setting by the light source controller 504, it is considered that a problem is less likely to occur even if the number of light source adjustment images is large. In this case, by increasing the number of light source adjustment images, the irradiation setting can be determined with higher accuracy. Therefore, it is conceivable to make the number of light source adjustment images larger than the number of three-dimensional data generation images, for example.

In this case, at the time of photographing the three-dimensional data generation image, the light source controller 504 causes a smaller number of the cameras 502 (for example, some of the cameras 502 in the photographing unit 50) than that at the time of acquiring the light source adjustment image, for example, to perform photographing. In this case, at the time of acquiring the light source adjustment image, the light source controller 504 causes the camera 502 to acquire a plurality of light source adjustment images photographed from a plurality of viewpoints more than those at the time of acquiring the three-dimensional data generation image. This makes it possible to more appropriately determine the irradiation setting with higher accuracy while preventing an increase in the burden on processing of generating three-dimensional data (for example, burden on the computer). Depending on the accuracy required for the irradiation setting and the like, there may be a case where the irradiation setting can be appropriately determined with a smaller number of light source adjustment images. Therefore, in another modification of the operation of generating three-dimensional data, it is conceivable to make the number of light source adjustment images smaller than the number of three-dimensional data generation images, for example.

As described above, the 3D scanner 5 (three-dimensional data generation apparatus) according to the present embodiment has the following configuration.

(13) The 3D scanner 5 generates three-dimensional data that is data indicating the three-dimensional shape and color of the three-dimensional target object T.

The 3D scanner 5 includes the light source 503 that irradiates the target object T with light, the camera 502 that photographs the target object T, the light source controller 504 that controls the operation of the light source 503, the photographing controller 505 that controls the operation of the camera 502, and the three-dimensional data generator 51 that generates three-dimensional data based on an image of the target object T photographed by the camera 502.

The photographing controller 505 causes the camera 502 to photograph the target object T, to acquire a light source adjustment image that is an image used for adjusting the light source 503, and a three-dimensional data generation image that is an image used for generating three-dimensional data in the three-dimensional data generator 51.

At least at the time of acquiring the light source adjustment image, the color target 9 (color sample) indicating a preset color is installed around the target object T.

The photographing controller 505 causes the camera 502 to acquire the light source adjustment image in a state where the color target 9 is installed around the target object T.

Based on the color target 9 appearing in the light source adjustment image, the light source controller 504 determines the irradiation setting that is a light irradiation manner of irradiating the light source 503 with light at the time of acquiring the three-dimensional data generation image.

At the time of acquiring the three-dimensional data generation image, the light source controller 504 causes the light source 503 to irradiate the target object T with light based on the irradiation setting.

With this configuration, by using the plurality of light source adjustment images acquired in a state where the color target 9 is installed around the target object T, it is possible to appropriately detect how the light of the light source 503 illuminates the target object T. By adjusting the illumination condition based on this detection result, how the light of the light source 503 illuminates the target object T can be brought close to a desired condition.

Hence, it is possible to appropriately adjust the manner of light irradiation at the time of acquiring a three-dimensional data generation image. At the time of generating three-dimensional data, it is possible to appropriately detect the color of the target object T with higher accuracy, and to appropriately perform generation of the three-dimensional data with higher accuracy.

The 3D scanner 5 (three-dimensional data generation apparatus) according to the present embodiment has the following configuration.

(14) In a state where the plurality of color targets 9 are installed at different positions from one another around the target object T, the photographing controller 505 causes the camera 502 to photograph the target object T to acquire the light source adjustment image.

The light source controller 504 detects how light illuminates each portion of the target object T based on each color target 9 appearing in the light source adjustment image, and determines the irradiation setting based on the detected way the light illuminates.

With this configuration, since the irradiation setting can be made in consideration of how light illuminates each portion of the target object T, the three-dimensional data generation image can be acquired in a state where each portion of the target object T is uniformly irradiated with the light.

The 3D scanner 5 (three-dimensional data generation apparatus) according to the present embodiment has the following configuration.

(15) The light source controller 504 detects a portion of the target object T with insufficient light illumination based on each of the color targets 9 appearing in the light source adjustment image, and determines the irradiation setting so that the portion with insufficient light illumination is irradiated with more light than light at the time of acquiring the light source adjustment image.

With this configuration, the three-dimensional data generation image can be acquired in a state where the target object T is appropriately irradiated with light.

The 3D scanner 5 (three-dimensional data generation apparatus) according to the present embodiment has the following configuration.

(16) At the time of acquiring a light source adjustment image, the photographing controller 505 causes the camera 502 to photograph the target object T from a plurality of different viewpoints from one another to acquire a plurality of light source adjustment images.

The light source controller 504 determines the irradiation setting based on the color targets 9 appearing in the plurality of light source adjustment images.

With this configuration, it is possible to appropriately detect a portion with insufficient light illumination in the target object T.

The 3D scanner 5 (three-dimensional data generation apparatus) according to the present embodiment has the following configuration.

(17) At the time of acquiring a three-dimensional data generation image, the photographing controller 505 causes the camera 502 to photograph the target object T from a plurality of different viewpoints from one another to acquire a plurality of three-dimensional data generation images.

At the time of acquiring a light source adjustment image,

the photographing controller 505 causes the camera 502 to photograph the target object T from a plurality of viewpoints more than those at the time of acquiring a three-dimensional data generation image to acquire a plurality of light source adjustment images.

With this configuration, it is possible to appropriately determine the irradiation setting while preventing an increase in the burden on processing of generating three-dimensional data.

The 3D scanner 5 (three-dimensional data generation apparatus) according to the present embodiment has the following configuration.

(18) The 3D scanner 5 includes the plurality of light sources 503.

The light source controller 504 determines the irradiation setting indicating the manner of light irradiation by each of the plurality of light sources 503 based on the color target 9 appearing in the light source adjustment image.

At the time of acquiring the three-dimensional data generation image, the light source controller 504 causes the plurality of light sources 503 to irradiate the target object T with light based on the determined irradiation setting.

With this configuration, the target object T can be irradiated with light from a plurality of directions. Then, by controlling each light source 503, the manner of light irradiation from each direction can be variously changed. Hence, the target object T can be irradiated with light more appropriately.

The 3D scanner 5 (three-dimensional data generation apparatus) according to the present embodiment has the following configuration.

(19) The 3D scanner 5 includes the plurality of light sources 503 having different color rendering indices from one another.

With this configuration, the color rendering indices obtained by the plurality of light sources 503 can be variously changed by adjusting the manner of light irradiation by each light source 503. At the time of acquiring the three-dimensional data generation image, it is possible to more variously change the manner of irradiating the target object T with light.

The 3D scanner 5 (three-dimensional data generation apparatus) according to the present embodiment has the following configuration.

(20) Also at the time of acquiring the three-dimensional data generation image, the color target 9 is installed around the target object T.

In a state where the color target 9 is installed around the target object T, the photographing controller 505 causes the camera 502 to photograph the target object T to acquire a three-dimensional data generation image.

The three-dimensional data generator 51 performs color adjustment on the three-dimensional data generation image based on the color target 9 appearing in the three-dimensional data generation image.

With this configuration, color adjustment (correction) such as color matching can be performed on the three-dimensional data generation image as necessary at the time of generating the three-dimensional data. Therefore, it is possible to appropriately read the color of the target object T based on the three-dimensional data generation image. Thus, three-dimensional data indicating the color of the target object T with higher accuracy can be appropriately generated.

Even if a shadow part occurs in a part of the target object T in three-dimensional data generation image, color adjustment or the like for removing its influence can be appropriately performed.

As described above, it is also possible to specify as the shaping system 4 using the 3D scanner 5 (three-dimensional data generation apparatus) according to the present embodiment.

That is,

(21) The shaping system 4 that shapes the three-dimensional shaped article 80, the shaping system 4 including the 3D scanner 5 (three-dimensional data generation apparatus) that generates three-dimensional data that is data indicating the three-dimensional shape and color of the three-dimensional target object T, and the shaping apparatus 7 that shapes the three-dimensional shaped article 80 based on three-dimensional data.

The 3D scanner 5 includes the light source 503 that irradiates the target object T with light, the camera 502 that photographs the target object T, the light source controller 504 that controls the operation of the light source 503, the photographing controller 505 that controls the operation of the camera 502, and the three-dimensional data generator 104 that generates three-dimensional data based on an image photographed by the camera 502.

The photographing controller 505 causes the camera 502 to photograph the target object T, to acquire a light source adjustment image that is an image used for adjusting the light source 503, and a three-dimensional data generation image that is an image used for generating three-dimensional data in the three-dimensional data generator 51.

At least at the time of acquiring the light source adjustment image, the color target 9 (color sample) indicating a preset color is installed around the target object T.

The photographing controller 505 causes the camera 502 to acquire the light source adjustment image in a state where the color target 9 is installed around the target object T.

Based on the color target 9 appearing in the light source adjustment image, the light source controller 504 determines the irradiation setting that is a light irradiation manner of irradiating the light source 503 with light at the time of acquiring the three-dimensional data generation image.

At the time of acquiring the three-dimensional data generation image, the light source controller 504 causes the light source 503 to irradiate the target object T with light based on the determined irradiation setting.

With this configuration, by using the plurality of acquired light source adjustment images photographed in a state where the color target 9 is installed around the target object T, it is possible to appropriately detect how light illuminates the target object T at the time of photographing. Then, by adjusting the illumination condition based on the detection result, how light illuminates the target object T can be brought close to a desired condition.

Therefore, since the color of the target object T can be appropriately detected with higher accuracy at the time of generating the three-dimensional data, the three-dimensional data can be appropriately generated with higher accuracy.

Hence, the three-dimensional shaped article can be appropriately shaped based on the three-dimensional data generated with high accuracy.

It is also possible to specify as the three-dimensional data generation method using the 3D scanner 5 (three-dimensional data generation apparatus) according to the present embodiment.

That is,

(22) A three-dimensional data generation method for generating three-dimensional data that is data indicating the three-dimensional shape and color of the three-dimensional target object T, the three-dimensional data generation method including the light source 503 that irradiates the target object T with light, and the camera 502 that photographs the target object T.

The camera 502 is caused to photograph the target object T, to acquire a light source adjustment image that is an image used for adjusting the light source 503, and a three-dimensional data generation image that is an image used for generating three-dimensional data.

At least at the time of acquiring the light source adjustment image, the color target 9 indicating a preset color is installed around the target object T, and the camera 502 is caused to acquire the light source adjustment image.

Based on the color target 9 appearing in the light source adjustment image, the irradiation setting, which is the manner of irradiating the light source 503 with light at the time of acquiring the three-dimensional data generation image, is determined.

At the time of acquiring the three-dimensional data generation image, the light source controller 504 causes the light source 503 to irradiate the target object T with light based on the determined irradiation setting, and three-dimensional data is generated based on the three-dimensional data generation image acquired by the camera 502.

With this configuration, by using the plurality of light source adjustment images photographed in a state where the color target 9 is installed around the target object T, it is possible to appropriately detect how light illuminates the target object T at the time of photographing. Then, by adjusting the illumination condition based on the detection result, how light illuminates the target object T can be brought close to a desired condition.

Therefore, since the color of the target object T can be appropriately detected with higher accuracy, the three-dimensional data can be appropriately generated with high accuracy.

### Modification

In the above, the purpose of using the color target 9 is mainly control of the light source 503 and adjustment of the color, but is not limited thereto. The color target 9 can also be used for other purposes. For example, at least a part of the color target 9 can be used as a feature point in image processing.

“Using at least a part of the color target 9 as a feature point” means using a part indicating, for example, a predetermined color in the color target as a feature point. In addition, “using at least a part of the color target as a feature point” may mean using a portion other than a part indicating, for example, a predetermined color as a feature point.

For example, as illustrated in (c) of FIG. 19, when the color target 9 having the marker 95 is used, the marker 95 can be used as a feature point. Only a part of the plurality of markers 95 may be used as a feature point.

The three-dimensional data generator 51 performs image processing on a plurality of three-dimensional data generation images by using, as a feature point, at least a part of the color target 9 appearing in the three-dimensional data generation image. Specifically, the three-dimensional data generator 51 discriminates a common part in the plurality of three-dimensional data generation images by using the color target 9 as a feature point. Thus, generation of the three-dimensional data can be more appropriately performed with higher accuracy.

The 3D scanner 5 (three-dimensional data generation apparatus) according to the modification has the following configuration.

(23) Also at the time of acquiring the three-dimensional data generation image, the color target 9 is installed around the target object T.

In a state where the color target 9 is installed around the target object T, the photographing controller 505 causes the camera 502 to photograph the target object T from a plurality of different viewpoints to acquire a plurality of three-dimensional data generation images.

The three-dimensional data generator 51 generates three-dimensional data by performing image processing on the plurality of three-dimensional data generation images by using, as a feature point, at least a part of the color target 104 appearing in the three-dimensional data generation image.

With this configuration, it is possible to appropriately perform generation of the three-dimensional data with higher accuracy.

### Other Embodiments

Although the embodiment described above is an example of a preferred embodiment of the present invention, the present invention is not limited thereto, and various modifications can be made within the technical scope of the present invention.

The color target 9 used at the time of photographing the light source adjustment image and the three-dimensional data generation image is an example of a color sample indicating a preset color. As the color target 9, a color chart same as or similar to a commercially-available, known color chart can be suitably used. In a modification of the operation of generating three-dimensional data, a color sample (for example, a color sample indicating a color matching the target object T) created in accordance with the target object T, for example, may be used. As such a color sample, for example, a color sample indicating a color of a particularly important part in the target object T can be suitably used. A color chart or the like indicating a plurality of colors can be suitably used as a color sample.

The case where three-dimensional data generated in the 3D scanner 5 is mainly used for the shaping of a three-dimensional shaped article has been described, but the present invention is not limited thereto. For example, it is conceivable to use it for the intended purpose of generating a computer graphics image (CG image) indicating the target object T.

### REFERENCE SIGNS LIST

1 to 1C Photographing apparatus for photogrammetry

2 Shaping apparatus

4 Shaping system

5 3D scanner

6 Control PC

7 Shaping apparatus

9 Color target

10 Photographing device

101 Image-capturing unit

102 Primary storage

103 Signal output unit

11 Controller

111 Control unit

112 Secondary storage

12 Display device

121 Display controller

122 Display unit

31 Pole

32 Moving unit

33 Guide rail

34 Coupling section

35 Rod-shaped portion

36 Main portion

50 Photographing unit

501 Stage

502 Camera

503 Light source

504 Light source controller

505 Photographing controller

51 Three-dimensional data generator

61 Data input unit

62 Data output unit

63 Display unit

64 Data processor

71 Head unit

72 Shaping table

73 Scanning driving unit

74 Control unit

80 Three-dimensional shaped article

90 Patch portion

95 Marker

S Shaped article set

T Target object

To the claims:

1. A photographing apparatus for photogrammetry that continuously photographs a target object performing a series of motions by synchronizing a plurality of image-capturing devices provided at a plurality of different viewpoints, wherein
each of the plurality of image-capturing devices includes
a plurality of image-capturing units that photograph the target object,
a plurality of primary storages each store each image data of the target object photographed in synchronization by the plurality of image-capturing units, and
a plurality of signal output units each output a completion signal for each of the image data when storage of each of the image data in a preceding motion of the target object into the plurality of primary storages is completed, and
the plurality of image-capturing devices perform photographing in a subsequent motion of the target object based on the completion signal of the signal output unit.

2. The photographing apparatus for photogrammetry as set forth in claim 1 further comprising:
a control unit to which the completion signal from the signal output unit of each of the plurality of image-capturing devices is input, wherein
when determining that storage of the image data into the primary storage has been completed in all the image-capturing devices based on the input completion signal, the control unit causes the plurality of image-capturing devices to execute photographing in a subsequent motion of the target object.

3. The photographing apparatus for photogrammetry as set forth in claim 1 further comprising:
a secondary storage to which the image data obtained by photographing a preceding motion of the target object stored in the primary storage of the image-capturing device is transferred and that stores the image data obtained by photographing the series of motions of the target object, wherein
the signal output unit outputs the completion signal when the image data stored in the primary storage is transferred to the secondary storage and then the transferred image data is erased from the primary storage.

4. A shaping apparatus comprising:
a display unit that displays the image data stored in the secondary storage of the photographing apparatus for photogrammetry as set forth in claim 3, wherein
the shaping apparatus generates three-dimensional data for shaping a three-dimensional shaped article from the plurality of image data selected in a display device in which the image data for shaping the three-dimensional shaped article can be selected from the plurality of image data displayed on the display unit, and shapes the three-dimensional shaped article based on the generated three-dimensional data.

5. A shaped article set in which a plurality of the three-dimensional shaped articles showing the series of motions shaped by the shaping apparatus as set forth in claim 4 are arranged side by side.

6. A photographing apparatus for photogrammetry that photographs a target object from a plurality of different viewpoints, the photographing device comprising:
a plurality of photographing devices that photograph the target object;
a plurality of poles to which the plurality of photographing devices are attached, the plurality of poles being provided to surround the target object; and
a plurality of moving units that move each of the plurality of poles close to or away from the target object, wherein
the moving unit includes a regulation member that regulates a path on which the pole moves, and
the pole is regulated by the regulation member to move on the path.

7. The photographing apparatus for photogrammetry as set forth in claim 6, further comprising:
a coupling section that couples the plurality of poles, wherein
the plurality of poles are moved by the plurality of moving units in synchronization by the coupling section.

8. The photographing apparatus for photogrammetry as set forth in claim 7, wherein one end portions of the plurality of poles are coupled to the coupling section, and other end portions are coupled to a guiding unit as the regulation member.

9. The photographing apparatus for photogrammetry as set forth in claim 7, wherein
the coupling section includes
a plurality of rod-shaped portions coupled to one end portions of the plurality of poles, and
a main portion coupled to end portions of the plurality of rod-shaped portions on a side opposite to a side on which the poles are coupled, and bundling the plurality of rod-shaped portion, and
the coupling section couples the plurality of poles so as to be able to approach one another.

10. The photographing apparatus for photogrammetry as set forth in claim 6, wherein
the plurality of poles are arranged side by side in a circumferential direction around the target object, and
the plurality of moving units are arranged such that the path extends in a radial direction orthogonal to the circumferential direction.

11. A three-dimensional data generation apparatus that generates three-dimensional data that is data indicating a three-dimensional shape and color of a three-dimensional target object, the three-dimensional data generation apparatus comprising:
a light source that irradiates the target object with light;
a camera that photographs the target object;
a light source controller that controls a motion of the light source;
a photographing controller that controls an operation of the camera; and
a three-dimensional data generator that generates the three-dimensional data based on an image photographed by the camera, wherein
the photographing controller causes the camera to photograph the target object,
to acquire a light source adjustment image that is an image used for adjusting the light source, and
a three-dimensional data generation image that is an image used for generating the three-dimensional data in the three-dimensional data generator,
at least at a time of acquiring the light source adjustment image, a color sample indicating a preset color is installed around the target object,
the photographing controller causes the camera to acquire the light source adjustment image in a state where the color sample is installed around the target object, and
the light source controller determines irradiation setting that is a manner of irradiating the light source with light at a time of acquiring the three-dimensional data generation image based on the color sample appearing in the light source adjustment image, and causes the light source to irradiate the target object with light based on the irradiation setting at a time of acquiring the three-dimensional data generation image.

12. The three-dimensional data generation apparatus as set forth in claim 11, wherein
the photographing controller causes the camera to acquire the light source adjustment image in a state where a plurality of the color samples are installed at different positions from one another around the target object, and
the light source controller detects a way light illuminates each portion of the target object based on each of the color samples appearing in the light source adjustment image, and determines the irradiation setting based on the detected way the light illuminates.

13. The three-dimensional data generation apparatus as set forth in claim 12, wherein the light source controller detects a portion of the target object with insufficient light illumination based on each of the color samples appearing in the light source adjustment image, and determines the irradiation setting so that the portion with insufficient light illumination is irradiated with more light than light at a time of acquiring the light source adjustment image.

14. The three-dimensional data generation apparatus as set forth in claim 11, wherein
at a time of acquiring the light source adjustment image, the photographing controller causes the camera to photograph the target object from a plurality of different viewpoints from one another to acquire a plurality of the light source adjustment images, and
the light source controller determines the irradiation setting based on the color sample appearing in the plurality of light source adjustment images.

15. The three-dimensional data generation apparatus as set forth in claim 14, wherein
at a time of acquiring the three-dimensional data generation image, the photographing controller causes the camera to photograph the target object from a plurality of different viewpoints from one another to acquire a plurality of the three-dimensional data generation images, and
at a time of acquiring the light source adjustment image, the photographing controller causes the camera to photograph the target object from a plurality of viewpoints more than viewpoints at the time of acquiring the three-dimensional data generation image to acquire a plurality of the light source adjustment images.

16. The three-dimensional data generation apparatus as set forth in claim 11 comprising:
a plurality of the light sources, wherein
the light source controller determines the irradiation setting indicating a light irradiation manner by each of the plurality of light sources based on the color sample appearing in the light source adjustment image, and causes the plurality of light sources to irradiate the target object with light based on the irradiation setting at a time of acquiring the three-dimensional data generation image.

17. The three-dimensional data generation apparatus as set forth in claim 16 comprising:
a plurality of the light sources having different color rendering indices from one another.

18. The three-dimensional data generation apparatus as set forth in claim 11, wherein
the color sample is installed around the target object also at a time of acquiring the three-dimensional data generation image,
the photographing controller causes the camera to acquire the three-dimensional data generation image in a state where the color sample is installed around the target object, and
the three-dimensional data generator adjusts a color of the three-dimensional data generation image based on the color sample appearing in the three-dimensional data generation image.

19. The three-dimensional data generation apparatus as set forth in claim 11, wherein
the color sample is installed around the target object also at a time of acquiring the three-dimensional data generation image,
the photographing controller causes the camera to photograph the target object from a plurality of different viewpoints from one another in a state where the color sample is installed around the target object and acquire a plurality of the three-dimensional data generation images, and
the three-dimensional data generator generates the three-dimensional data by performing image processing on the plurality of three-dimensional data generation images using, as a feature point, at least a part of the color sample appearing in the three-dimensional data generation image.

20. A shaping system that shapes a three-dimensional shaped article, the shaping system comprising:
a three-dimensional data generation apparatus that generates three-dimensional data that is data indicating a three-dimensional shape and color of a three-dimensional target object; and
a shaping apparatus that shapes a shaped article based on the three-dimensional data, wherein
the three-dimensional data generation apparatus includes
a light source that irradiates the target object with light,
a camera that photographs the target object,
a light source controller that controls a motion of the light source,
a photographing controller that controls an operation of the camera, and
a three-dimensional data generator that generates the three-dimensional data based on an image photographed by the camera,
the photographing controller causes the camera to photograph the target object,
to acquire a light source adjustment image that is an image used for adjusting the light source, and
a three-dimensional data generation image that is an image used for generating the three-dimensional data in the three-dimensional data generator,
at least at a time of acquiring the light source adjustment image, a color sample indicating a preset color is installed around the target object,
the photographing controller causes the camera to acquire the light source adjustment image in a state where the color sample is installed around the target object, and
the light source controller determines irradiation setting that is a manner of irradiating the light source with light at a time of acquiring the three-dimensional data generation image based on the color sample appearing in the light source adjustment image, and causes the light source to irradiate the target object with light based on the irradiation setting at a time of acquiring the three-dimensional data generation image.
